(19) United States
(12) Patent Application Publication
(10) Pub. No.: US 2018/0361904 A1
(43) Pub. Date: Dec. 20, 2018

(54) UTV SHELTER

(71) Applicant: Todd M. Huntimer, Arlington, SD (US)

(72) Inventor: Todd M. Huntimer, Arlington, SD (US)

(21) Appl. No.: 16/111,073

(22) Filed: Aug. 23, 2018

Related U.S. Application Data
(63) Continuation-in-part of application No. 15/867,342, filed on Jan. 10, 2018.
(60) Provisional application No. 62/445,128, filed on Jan. 11, 2017.

(51) Int. Cl. B60P 3/34; B60J 5/12

(52) U.S. Cl. CPC B60P 3/34; B60Y 2200/20; B60J 5/125

(57) ABSTRACT

Embodiments are directed to an expandable shelter. The expandable shelter may include a slide box, a skirt, and a winch. The skirt may be slidably coupled to the slide box, with the skirt being vertically slidable relative to the slide box. The winch may raise and lower the skirt relative to the slide box.

### PRIORITY CLAIM

The present application is a Continuation-in-Part of U.S. patent application Ser. No. 15/867,342, entitled UTV SHELTER, filed Jan. 10, 2018, which is a non-provisional utility application of U.S. Provisional Application Ser. No. 62/445,128, entitled UTV SHELTER, filed Jan. 11, 2017, in which the contents of each are hereby incorporated by reference.

### FIELD OF THE INVENTION

This application relates to shelters for use with vehicles and, more particularly, yet not exclusively, outdoor shelters deployable from land vehicles.

### BACKGROUND OF THE INVENTION

Ice shanties may be transported to or across frozen lakes with vehicles, such as side-by-side utility terrain vehicles (UTVs). Non-packable shanties must be towed by the LOWE GRAHAM JONES vehicle, requiring additional equipment to transport the shanties. Packable shanties are often transported in a cargo box or space of the vehicle, leaving very little room for other gear or supplies. Thus, it is with regard to these considerations and others that the present invention has been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of the Preferred Embodiment, which is to be read in association with the accompanying drawings, wherein:

FIG. 1 is an isometric view of an example shelter in a nested configuration with a slide box of the shelter nested in a main box of the shelter, as it would be situated during transportation or storage in a vehicle, such as transportation or storage in a cargo box of a side-by-side utility terrain vehicle (UTV);

FIG. 2 is an isometric view of the shelter of FIG. 1 in an extended configuration, with the slide box extended from the main box of the shelter;

FIG. 3 is an isometric view of the shelter of FIG. 1 in a deployed configuration, with a skirt of the shelter deployed from the slide box;

FIG. 4 is an isometric view of the shelter of FIG. 1 in the deployed configuration, with doors of the shelter being open;

FIG. 5 is an isometric side view of the shelter of FIG. 1 in the nested configuration, positioned in a cargo box of an example side-by-side UTV;

FIG. 6 is an isometric side view of the shelter of FIG. 5 in the extended configuration, positioned in the cargo box of the side-by-side UTV of FIG. 5;

FIG. 7 is an isometric side view of the shelter of FIG. 6 in the deployed configuration, positioned in the cargo box of the side-by-side UTV of FIG. 5;

FIG. 8 is an isometric side view of the shelter of FIG. 1 in the nested configuration, positioned in a cargo box of the side-by-side UTV of FIG. 5, with the shelter being sized and dimensioned to fit in the cargo box in the nested configuration with the tailgate closed;

FIG. 9 is an isometric side view of the shelter of FIG. 8 in the deployed configuration, positioned in the cargo box of the side-by-side UTV of FIG. 8;

FIG. 10 is an isometric view of the shelter of FIG. 1 in the nested configuration, positioned in the cargo box of the side-by-side UTV of FIG. 5, with sidewalls removed to show several internal features;

FIG. 11 is an isometric view of the shelter of FIG. 1 in the nested configuration, positioned in the cargo box of the side-by-side UTV of FIG. 5, with sidewalls removed to show several internal features;

FIG. 12 is an isometric view of the shelter of FIG. 1 in the extended configuration, positioned in the cargo box of the side-by-side UTV of FIG. 5, with sidewalls removed to show several internal features;

FIG. 13 is an isometric side view of the shelter of FIG. 1 in the deployed configuration, positioned in the cargo box of the side-by-side UTV of FIG. 5, with sidewalls removed to show several internal features;

FIG. 14 is an isometric side view of the shelter of FIG. 1 in the extended configuration, positioned in the cargo box of the side-by-side UTV of FIG. 5, with sidewalls and the doors removed to show several internal features;

FIG. 15 is an isometric view of the shelter of FIG. 1 in the nested configuration, with sidewalls removed to show several internal features;

FIG. 16 is an isometric view of a portion of the shelter of FIG. 1 in the deployed configuration, with sidewalls removed to show several internal features;

FIG. 17 is an isometric view of an example suspension stabilizer in a stored configuration; and

FIG. 18 is an isometric view of the suspension stabilizer of FIG. 17 in a stabilizing configuration.

### SUMMARY OF THE INVENTION

The following briefly describes example embodiments of the invention in order to provide a basic understanding of some aspects of the invention. This brief description is not intended as an extensive overview. It is not intended to identify key or critical elements or to delineate or otherwise narrow the scope. Its purpose is merely to present some concepts in a simplified form as a prelude to the more detailed description that is presented later.

Briefly stated, various embodiments are directed to an expandable shelter. In one or more of the various embodiments, the expandable shelter may include a slide box. In some of the various embodiments, the expandable shelter may include a skirt. In some embodiments, the skirt may be slidably coupled to the slide box, with the skirt being vertically slidable relative to the slide box. In some embodiments, the expandable shelter may include a prime mover that raises and lowers the skirt relative to the slide box.

In one or more of the various embodiments, the slide box may have multiple side walls. In some of the various embodiments, the prime mover may be mounted inside the slide box. In some embodiments, the prime mover may be spaced apart from each of the side walls of the slide box.

In one or more of the various embodiments, the expandable shelter may include a main box, a first track, a second track, a first roller, and a second roller. In some of the various embodiments, the main box may have a first side wall, a second side wall, and a side opening. In some embodiments, the first and second side walls may be disposed opposite the side opening from each other. In some embodiments, the first track may extend along an inner face of the first side wall of the main box. In some embodiments, the second track may extend along an inner face of the second side wall of the main box. In some embodiments, the first roller may fixedly couple to an external face of a first side wall of the slide box. In some embodiments, the first roller may be slidably coupled to the first track. In some embodiments, the second roller may be fixedly coupled to an external face of a second side wall of the slide box. In some embodiments, the second roller may be slidably coupled to the second track. In some embodiments, the slide box may be slidable at least partially through the side opening of the main box.

In one or more of the various embodiments, a main box may have a side opening and one or more wedges. In some of the various embodiments, the slide box may be slidably coupled to the main box. In some embodiments, the slide box may be slidable at least partially through the side opening of the main box. In some embodiments, the one or more wedges may extend along a bottom of one or more sides of the main box. In some embodiments, the one or more wedges may have one or more end portions that are vertically adjustable relative to the main box. In some embodiments, vertical adjustment of the one or more wedges may raise or lower a portion of the main box.

In one or more of the various embodiments, the skirt may have a front wall that collapses when the skirt slides toward the slide box and that extends when the skirt slides away from the slide box.

In one or more of the various embodiments, the skirt may have a front wall that is vertically slidable relative to the slide box and relative to the skirt.

In one or more of the various embodiments, the skirt may have a bottom lip that includes ultra high molecular weight (UHMW) plastic.

In one or more of the various embodiments, a main box may have a side opening and an auger mount. In some of the various embodiments, the slide box may be slidably coupled to the main box, with the slide box being slidable at least partially through the side opening of the main box. In some embodiments, the auger mount may have one or more hooks and a blade cover at an end portion of the auger mount.

In one or more of the various embodiments, the expandable shelter may include a suspension stabilizer. In some of the various embodiments, the suspension stabilizer may include a mount shank and a stabilizing body. In some embodiments, the mount shank may be sized and dimensioned to be received in a hitch receiver. In some embodiments, the stabilizing body may be pivotally coupled to the mount shank. In some embodiments, the stabilizing body may be pivotable relative to the mount shank between a stabilizing configuration and a stored configuration. In some embodiments, transitioning the suspension stabilizer in the hitch receiver from the stored configuration to the stabilizing configuration may increase a vertical distance between ground and the hitch receiver.

In one or more of the various embodiments, a suspension stabilizer may include a mount shank. In some of the various embodiments, the mount shank may be sized and dimensioned to be received in a hitch receiver. In some embodiments, the suspension stabilizer may be transitionable between a stabilizing configuration and a stored configuration. In some embodiments, transitioning the suspension stabilizer in the hitch receiver from the stored configuration to the stabilizing configuration provides a step or footrest for a user in the skirt.

Also briefly stated, various embodiments are directed to an expandable shelter. In one or more of the various embodiments, the expandable shelter may include a main box, a slide box, a first track, a second track, a first roller, and a second roller. In some of the various embodiments, the main box may have a first side wall, a second side wall, and a side opening. In some embodiments, the first and second side walls of the main box may be disposed opposite the side opening from each other, and each of the first and second side walls of the main box may have an inner face. In some embodiments, the slide box may have a first side wall, a second side wall, and a bottom opening disposed between the first and second side walls, and each of the first and second side walls of the slide box may have an external face. In some embodiments, the slide box may be slidably coupled to the main box, with the slide box being slidable at least partially through the side opening of the main box. In some embodiments, the first track may extend along the inner face of the first side wall of the main box, and the second track may extend along the inner face of the second side wall of the main box. In some embodiments, the first roller may fixedly couple to the external face of the first side wall of the slide box, with the first roller being slidably coupled to the first track. In some embodiments, the second roller may fixedly couple to the external face of the second side wall of the slide box, with the second roller being slidably coupled to the second track.

In one or more of the various embodiments, the first roller and the first track may form a first drawer slide, and the second roller and the second track may form a second drawer slide. In some of the various embodiments, each of the first and second rollers may have multiple top bearings disposed above one of the first and second tracks and may have multiple lower bearings disposed under one of the first and second tracks.

Further briefly stated, various embodiments are directed to expanding a shelter. In one or more of the various embodiments, a slide box that houses a skirt may be provided. In some of the various embodiments, the skirt may be vertically slidable relative to the slide box. In some embodiments, a prime mover that raises or lowers the skirt relative to the slide box may be actuated.

In one or more of the various embodiments, a main box having a first side wall, a second side wall, and a side opening may be provided. In some of the various embodiments, the first and second side walls may be disposed opposite the side opening from each other. In some embodiments, the slide box may be slid at least partially through the side opening of the main box. In some embodiments, the slide box may have a first roller fixedly coupled to an external face of a first side wall of the slide box and may have a second roller fixedly coupled to an external face of a second side wall of the slide box. In some embodiments, the first roller may be slidably coupled to a first track that extends along an inner face of the first side wall of the main box. In some embodiments, the second roller may be slidably coupled to a second track that extends along an inner face of the second side wall of the main box.

In one or more of the various embodiments, a main box having one or more wedges may be provided. In some of the various embodiments, the slide box may be slidably coupled to the main box. In some embodiments, the one or more wedges may extend along a bottom of one or more sides of the main box. In some embodiments, the slide box may be slid at least partially through the side opening of the main box. In some embodiments, a vertical position of one or more end portions of the one or more wedges may be adjusted relative to the main box to raise or lower a portion of the main box.

In one or more of the various embodiments, the skirt may be slid away from the slide box, in some of the various embodiments, a front wall of the skirt may be extended. In some embodiments, the front wall of the skirt may be collapsed. In some embodiments, the skirt may be slid toward the slide box with the skirt being collapsed.

In one or more of the various embodiments, the skirt may have a bottom lip that includes ultra high molecular weight (UHMW) plastic.

In one or more of the various embodiments, a main box having an auger mount may be provided. In some of the various embodiments, the slide box may be slidably coupled to the main box. In some embodiments, the auger mount may have one or more hooks and a blade cover at an end portion of the auger mount. In some embodiments, an ice auger may be set onto the one or more hooks with a blade of the ice auger being at least partially covered by the blade cover.

In one or more of the various embodiments, a mount shank of a suspension stabilizer may be inserted into a hitch receiver. In some of the various embodiments, a stabilizing body of the suspension stabilizer may be pivoted relative to the hitch receiver to transition the suspension stabilizer from a stored configuration to a stabilizing configuration. In some embodiments, a vertical distance between ground and the hitch receiver may be greater when the suspension stabilizer is in the stabilizing configuration than when the suspension stabilizer is in the stored configuration.

In one or more of the various embodiments, a mount shank of a suspension stabilizer is inserted into a hitch receiver. In some of the various embodiments, the suspension stabilizer may be transitioned from a stored configuration to a stabilizing configuration to provide a step or footrest for a user in the skirt.

### DETAILED DESCRIPTION OF THE PREFERRED EMBODIMENTS

The various embodiments now will be described more fully hereinafter with reference to the accompanying drawings, which form a part hereof and show, by way of illustration, specific example embodiments by which the invention may be practiced. The embodiments may, however, be embodied in many different forms and should not be construed as limited to the embodiments set forth herein; rather, these embodiments are provided so that this disclosure will be thorough and complete and will fully convey the scope of the embodiments to those skilled in the art. Among other things, the various embodiments may be methods, systems, or devices. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator and is equivalent to the term “and/or,” unless the context clearly dictates otherwise. The term “based on” is not exclusive and allows for being based on additional factors not described, unless the context clearly dictates otherwise. In addition, the meaning of “a,” “an,” and “the” include plural references. Also, plural references are intended to also disclose the singular, unless the context clearly dictates otherwise. The meaning of “in” includes “in” and “on.” Also, the use of “when” and “responsive to” do not imply that associated resultant actions are required to occur immediately or within a particular time period. Instead, they are used herein to indicate actions that may occur or be performed in response to one or more conditions being met, unless the context clearly dictates otherwise.

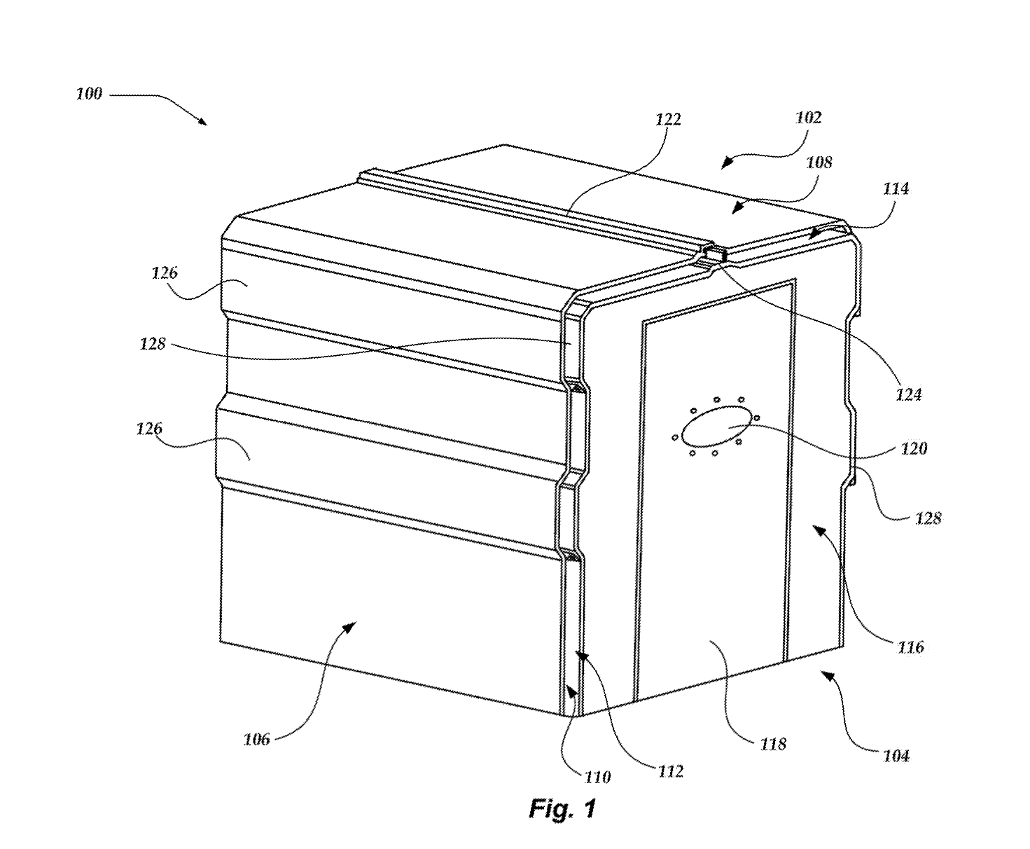

Referring to FIG. 1, example shelter 100 is shown in a nested configuration. Shelter 100 may include main box 102 and slide box 104. In the nested configuration, slide box 104 is disposed in or nested in main box 102. In one or more of the various embodiments, main box 102 may have left side wall 106, a right-side wall that is disposed opposite left side wall 106, top wall 108, a bottom wall that is disposed opposite top wall 108, rear opening 110, and a front wall that is disposed opposite rear opening 110. In some of the various embodiments, one or more intake or exhaust fans (for example, one or more small computer-type fans) may be disposed in one or more walls of shelter 100, such as the front wall of main box 102, to facilitate increasing intake or exhaust air flow into or out from the interior space of shelter 100. In some embodiments, the front wall may have a laterally extending panel that is spaced apart from the inner surface of the front wall (for example, spaced apart by 1, 2, 3, 4, or more inches). In some embodiments, the panel may form a storage space between the panel and the front wall and may provide storage for propane bottles. In some embodiments, slide box 104 may have left side wall 112, a right side wall disposed opposite left side wall 112, top wall 114, a bottom wall that is disposed opposite top wall 114, rear wall 116, and a front wall that is disposed opposite rear wall 116. In some embodiments, one or more of main box 102 or slide box 104 may lack one or more of the walls, such as one or more bottom or front walls, and may employ a surface of a vehicle or another surface such as the earth as one or more floors or walls in shelter 100.

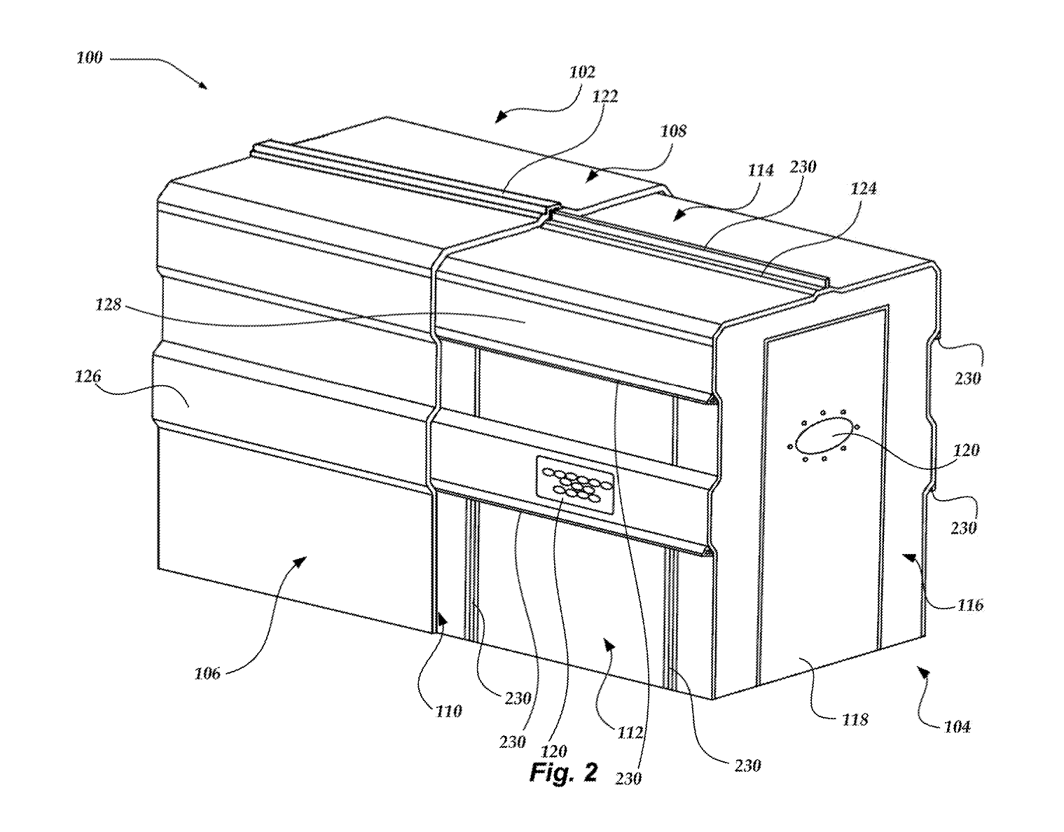

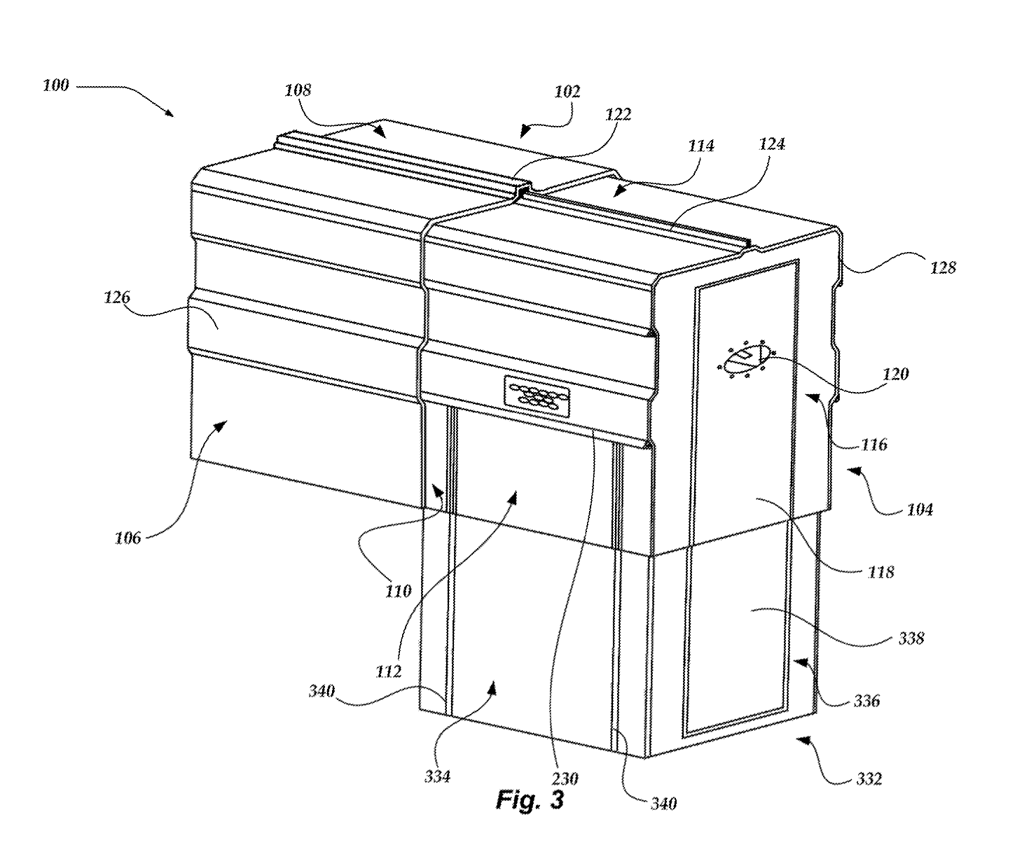

As shown in FIG. 1, main box 102 may have an internal width (distance from the inner surface of left wall 106 to the inner surface of the right wall of main box 102) that matches or slightly exceeds the external width of slide box 104 in the nested configuration (distance from the outer surface of left wall 112 to the outer surface of the right wall of slide box 104) to facilitate at least partially receiving slide box 104 in the internal space in main box 102. As illustrated in FIG. 1, main box 102 may have an internal height (distance from the inner surface of top wall 108 to the inner surface of the bottom wall of main box 102 or, in the absence of a bottom wall, the surface employed as the floor of main box 102) that matches or slightly exceeds the external height of slide box 104 in the nested configuration (distance from the outer surface of top wall 114 to the inner surface of the bottom wall of slide box 104 or, in the absence of a bottom wall, the surface employed as the floor of slide box 104 in the nested configuration) to facilitate at least partially receiving slide box 104 in the internal space in main box 102. As shown in FIG. 1, main box 102 may have an internal length (distance from opening 110 to the inner surface of the front wall of main box 102 or, in the absence of a front wall, the surface employed as the front wall of main box 102) that matches or is less than the external length slide box 104 in the nested configuration (distance from the inner surface of rear wall 116 to the front-most external surface of slide box 104 in the nested configuration) to facilitate increasing internal volume in the nested configuration and to facilitate providing easy access to grip slide box 104 to pull slide box 104 to an extended configuration (see FIG. 2) or a deployed configuration (see FIG. 3).

In one or more of the various embodiments, shelter 100 may have one or more doors, such as door 118 disposed in rear wall 116 of slide box 104, that provide physical access to the interior space of shelter 100. As illustrated in FIG. 1, outer door 112 may extend entirely to or across one or more bottom edges of rear wall 116 in the nested configuration. In some of the various embodiments, shelter 100 may have one or more windows, such as window 120 disposed in door 118, that provide visual access to the interior space of shelter 100 in the nested configuration. As shown in FIG. 1, visual access through one or more windows, such as window 120 may be blocked in the nested configuration and may be unblocked only in one or more other configurations, such as the extended configuration (see FIG. 2) or the deployed configuration (see FIG. 3).

In one or more of the various embodiments, main box 102 may have one or more top corrugations or ridges 122, and slide box 104 may have one or more corresponding top corrugations or ridges 124 that align with one or more top ridges 122 of main box 102. As shown in FIG. 1, one or more top ridges 122 may form one or more tracks that may receive one or more corresponding top ridges 124 of slide box 104, thereby facilitating laterally aligning the longitudinal axis of slide box 104 with the longitudinal axis of main box 102 and improving ease of sliding slide box 104 in and out of main box 102. In some embodiments, main box 102 may have one or more side corrugations or ridges 126, and slide box 104 may have one or more corresponding side corrugations or ridges 128 that align with one or more side corrugations 126 of main box 102. As illustrated in FIG. 1, one or more side corrugations 126 may receive one or more corresponding side corrugations 128 of side box 104, thereby facilitating vertically aligning the longitudinal axis of slide box 104 with the longitudinal axis of main box 102 and improving ease of sliding slide box 104 in and out of main box 102. As shown in FIG. 1, each top ridge 122 and side corrugation 126 of main box 102 may have an internal size that is slightly larger than the external size of each top ridge 124 and side corrugation 128 of slide box 104 to facilitate receiving each corresponding top ridge 124 and side corrugation 128 of slide box 104.

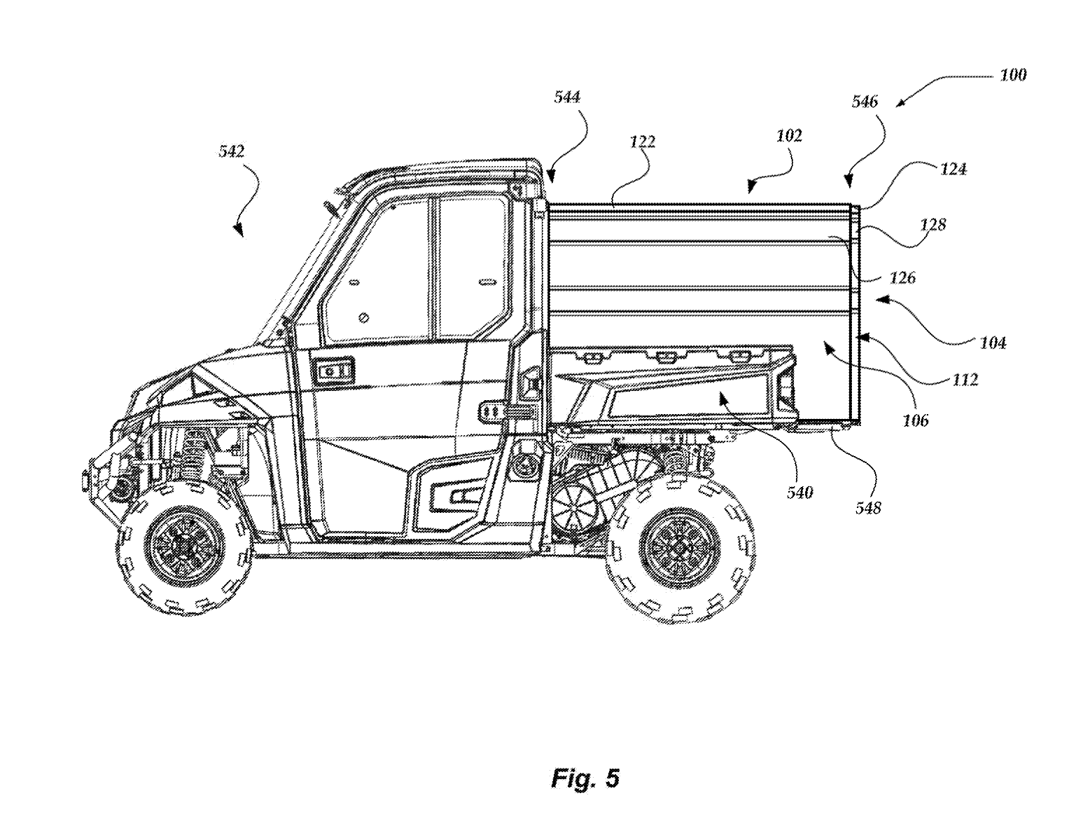

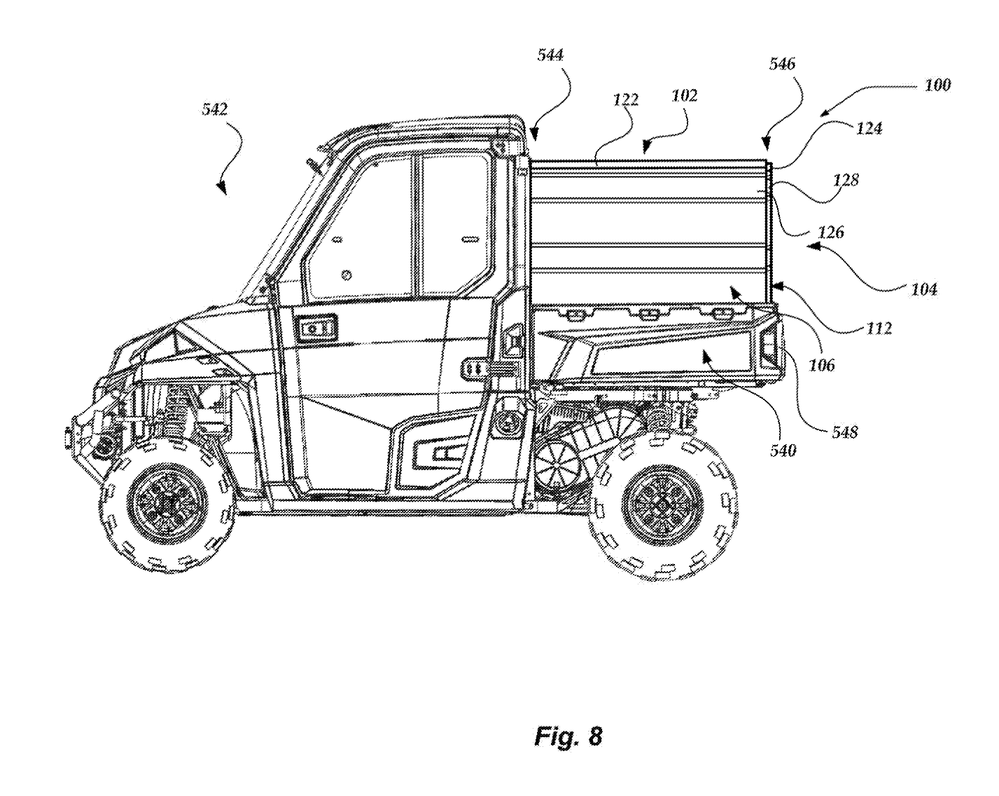

In one or more of the various embodiments, shelter 100 in the nested configuration may provide a cap or shell for a vehicle, such as a side-by-side utility terrain vehicle (UTV) (see FIGS. 5 and 8). Shelter 100 may be configured and sized to fit within the cargo box of a UTV and to be deployable therefrom when the UTV is stopped so as to provide a shelter. Such a shelter may be used, for example, as an ice house for fishing, as a hunting blind, or as a warming hut when expanded beyond the cargo box of the UTV. When in the nested configuration shown in FIG. 1, shelter 100 fits in the cargo box of the UTV and may be used to hold cargo. Thus, for most UTV cargo boxes, the width and depth of shelter 100 may be 48 inches by 48 inches. With these dimensions, shelter 100 in the nested configuration may fit in the cargo boxes of most UTVs currently on the market, at least with the tailgate of the UTV open (see FIG. 5). If the particular cargo box is longer than 48 inches, shelter 100 may be positioned at the rear of the box for ease of deployment.

Shelter 100 may be tapered or otherwise adapted or configured to fit the specific size of a certain UTV cargo box, as needed. Shelter 100 may also be sized to fit within a smaller or larger vehicle, such as a pickup truck. The height of shelter 100 is preferably also 48 inches, but may alternatively be shorter or taller. Anchors may be used to secure shelter 100 fixedly in the cargo box. For example, bolts or straps may be used to secure shelter 100 in the cargo box fixedly or even temporarily.

While in the cargo box of the UTV, items for transport (i.e., cargo) may be placed in shelter 100 through door 118. Deployment of slide box 104 from main box 102 does not necessarily require such cargo to be removed from the cargo box, as will be described below.

Shelter 100 is preferably constructed of sheet aluminum with riveted connections between panels. In some examples, the floor of main box 102 is wood, thereby facilitating increasing rigidity of main box 102. Other materials on constructions may alternatively be employed, such as roto-molded plastic. Door 118 may be hinged in any conventional manner, such as with a piano hinge. Door 118 may be used with slide box 104 nested as in FIG. 1 or with slide box 104 partially or fully extended or deployed as in FIGS. 2-4). Windows 120 may be provided in door 118 or sides of main box 104. Main box 102 preferably includes three sides (a front side, a right side, and a left side) as well as a top. Main box 102 may also have a floor and/or a back side in some alternate embodiments.

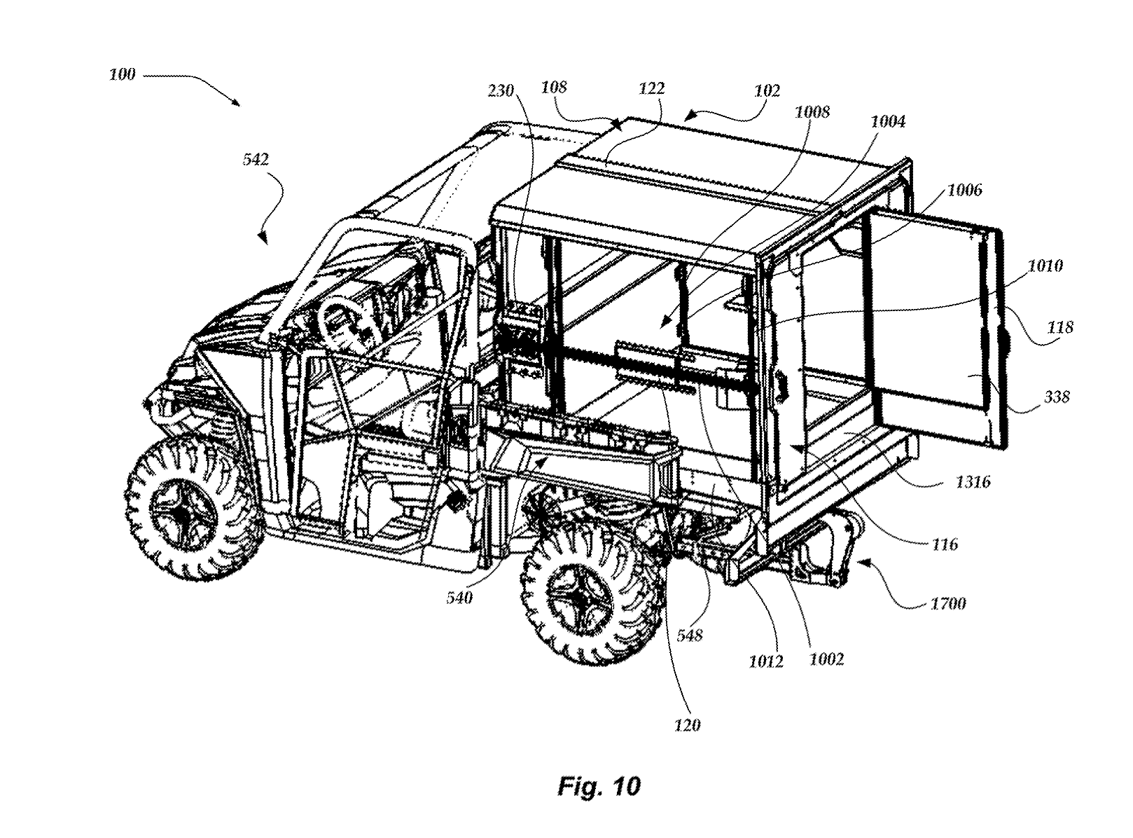

FIG. 2 shows shelter 100 in the extended configuration, with slide box 104 extended (pulled out) from main box 102. As shown in FIG. 2, the ridges and recesses of slider box 104 generally match and nest within those of main box 102. Such a configuration aligns slide box 104 with main box 102 for ease of deployment and retraction. Slots may be provided in main box 102 to receive the ridges of slide box 104. As illustrated in FIG. 2, the slots may include one or more longitudinal tracks, such as one or more rollers or low-friction tracks 230. In some embodiments, main box 102 may have one or more corresponding rollers or low-friction tracks that act in conjunction with one or more rollers or low-friction tracks 230 of slide box 104 to facilitate sliding slide box 104 relative to main box 102 (see FIGS. 10-14).

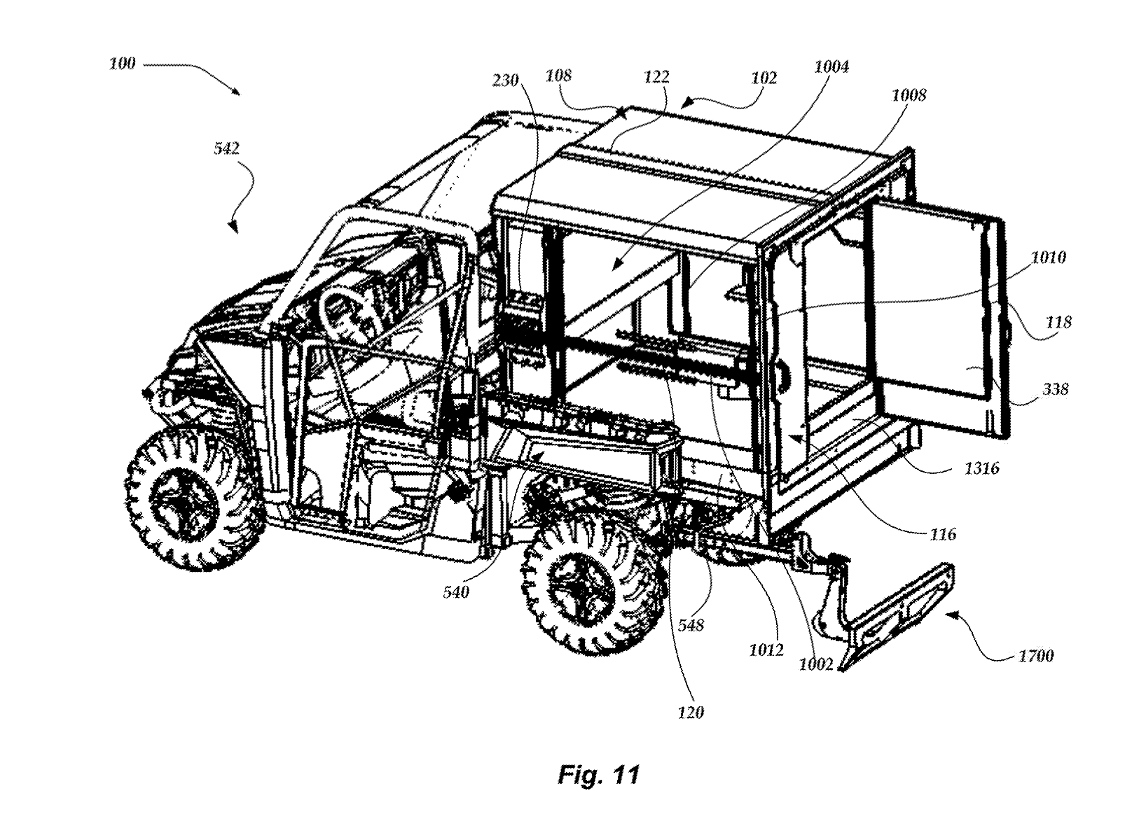

An ultra-high molecular weight (UHMW) plastic may be used within some or all of the slots to facilitate low-friction sliding while still providing alignment. Windows 120 may be provided in slide box 104. In one or more of the various embodiments, windows 120 may match up with windows in main box when in the nested configuration of FIG. 1. In some of the various embodiments, the windows may be open, have mesh or other venting material covering them as shown in FIG. 2, or have a pane of translucent material covering them. In some examples, a cover of one or more windows 120 may be slidable between a closed configuration (see FIG. 10) and an open configuration (see FIGS. 11-13). Open windows (or turrets) may be used for hunting, the user being able to extend a rifle through the turret, for example when the shelter is used as a hunting blind.

In one or more of the various embodiments, slide box 104 lacks a front wall in the nested and extended configurations, there by facilitating the slide box 104 sliding at least partially out of main box 102 without upsetting cargo in the interior space of shelter 100. For example, in the nested configuration, slide box 104 may have a bottom wall that slides rearward with the rest of slide box 104 to the extended configuration and, from the extended configuration, hinges or otherwise orients to become a vertical front wall below slide box 104 when shelter 100 is in the deployed configuration (see FIG. 3, providing a skirt having a front wall in the deployed configuration while slide box 104 lacks a front wall in the nested or extended configuration). Thus, with shelter 100 in the extended configuration, the uninterrupted interior volume is nearly doubled. A permanent floor is preferably not included with slide box 104 because slide box 104 may at least partially extend beyond the rear of the vehicle in the deployed configuration and may provide cover for a user standing on the ground behind the vehicle. Not shown in FIG. 2 are legs that may drop down to the ground when slide box 104 is extended from the shell. Also, an optional support member may extend from a hitch receiver of the vehicle to support the vehicle from suspension compression when slide box 104 is deployed (see FIGS. 10-13, 17, and 18).

As with main box 102, slide box 104 is preferably constructed of aluminum with panels riveted together. Other materials and constructions may alternatively be employed.

The interface between main box 102 and slide box 104 preferably includes flanges and seals. The flanges on slide box 104 may flare outwardly, while the flanges on main box 102 may flare inwardly such that the two interface each other at full extension of slide box 104 in the extended configuration and deployed configuration. The flanges (or other stopper) may maintain some overlap between main box 102 and slide box 104 to maintain structural integrity when in the extended configuration and deployed configuration shown in FIGS. 2-4. Seals (such as rubber) may also be used between main box 102 and slide box 104 to improve the integrity of shelter 100.

FIG. 3 illustrates shelter 100 in the deployed configuration, with skirt 332 of shelter 100 extended downward from slide box 104. In one or more of the various embodiments, skirt 332 may have left side wall 334, a right-side wall that is disposed opposite left side wall 334, rear wall 336, a front wall that is disposed opposite rear wall 336 (see FIGS. 10-15), and a bottom wall that is disposed opposite top wall 114 of slide box 104 (see FIGS. 10-13, 15, and 16). In some of the various embodiments, skirt 332 may lack one or more of the walls, such as one or more bottom or front walls.

As shown in FIG. 3, slide box 104 may have an internal width (distance from the inner surface of left wall 112 to the inner surface of the right wall of slide box 104) that matches or slightly exceeds the external width of skirt 332 (distance from the outer surface of left wall 334 to the outer surface of the right wall of skirt 332) to facilitate at least partially receiving skirt 332 in the internal space in slide box 104. As illustrated in FIGS. 1-3, slide box 104 may have an internal height (distance from the inner surface of top wall 114 to the bottom-most internal surface of slide box 104 in the deployed configuration) that matches or slightly exceeds the external height of skirt 332 in the nested or extended configuration (distance from top-most surface of skirt 332 to the inner surface of the bottom wall of skirt 332 or, in the absence of a bottom wall, the surface employed as the floor of skirt 332 in the deployed configuration) to facilitate at least partially receiving skirt 332 in the internal space in slide box 104. In other embodiments, the external height of skirt 332 may exceed the internal height of slide box 104 while remaining less than or equal to the internal height of main box 102. As shown in FIGS. 1-3, slide box 104 may have an internal length (distance from the inner surface of rear wall 116 to the front-most inner surface of slide box 104) that matches or is greater than the external length of skirt 332 in the nested or extended configuration (distance from the inner surface of rear wall 336 to the front-most external surface of skirt 332 in the nested or extended configuration).

In one or more of the various embodiments, skirt 332 may have one or more doors, such as door 338 disposed in rear wall 336 of slide box 332, that provide physical access to the interior space of shelter 100 in at least the deployed configuration. As shown in FIG. 3, door 338 of skirt 332 aligns with door 118 of slide box 104 in the deployed configuration to provide a larger door that is a combination of doors 338 and 118. As shown in FIGS. 1-3, door 338 of skirt 332 also aligns with door 118 of slide box 104 in the nested or extended configuration to provide a double-layer door and to block visual access to the interior space of shelter 100 through window 120.

In one or more of the various embodiments, one or more of slide box 104 or skirt 332 may have one or more vertical slots that receive one or more vertical ridges of the other. As shown in FIG. 3, the slots may include one or more vertical tracks, such as one or more rollers or low-friction tracks 340. In some embodiments, one or more of slide box 104 or skirt 332 may have one or more corresponding rollers or low-friction tracks that act in conjunction with one or more rollers or low-friction tracks 340 of the other to facilitate sliding skirt 332 relative to slide box 104 (see FIGS. 10-13, 15, and 16).

Left wall 334, the right wall, and rear wall 336 of skirt 332 are preferably 32 inches tall. Skirt 332 may retract up into slide box 104 when not in use. Other support walls and/or bracing may be included, such as on the front side of skirt 332 to provide structural integrity to skirt 332. However, skirt 332 preferably provides clearance to deploy and retract without removal of cargo in the rear of the UTV. Thus, any such braces or walls may be configured to be out of the way of the cargo or to be moveable to not interfere with the cargo during extension and retraction. Preferably, at least a partial upper wall (8-10 inches) is provided across the front of skirt 332. The front wall may provide structure without substantial interference with the cargo in the UTV box when skirt 332 is slid within main box 102 along with slide box 104 when transitioning shelter 100 between the nested configuration and the extended configuration.

As skirt 332 is extended vertically into or from slide box 104, the vertical slots may cooperate to maintain proper alignment of skirt 332 relative slide box 104. The vertical slots may include ridges and corresponding tracks or grooves, one or more of which may include UHMW as between slide box 104 and main box 102. When the above-mentioned legs are employed to provide support to slide box 104, skirt 332 does not need to do so yet may optionally lock into place in the deployed configuration to provide additional support to slide box 104. Flanges may be used between skirt 332 and slide box 104 in a manner similar to that discussed above in connection with the interface between main box 102 and slide box 104. Skirt 332 may extend to and be supported by the ground, or skirt 332 may be configured to extend to a position above and spaced apart from the ground, supported and held above the ground by the interface with the slider. Such positioning may depend on the box height of the UTV and the slope of the ground.

Skirt 332 does not need to carry the load of slider 104 or main box 102 but does provide protection from the elements to shelter the user. A lock is preferably provided such that skirt 332 cannot be deployed unless the legs and/or hitch support is in place. A lock may also be provided such that door 118 cannot be opened unless the legs or hitch support is in place.

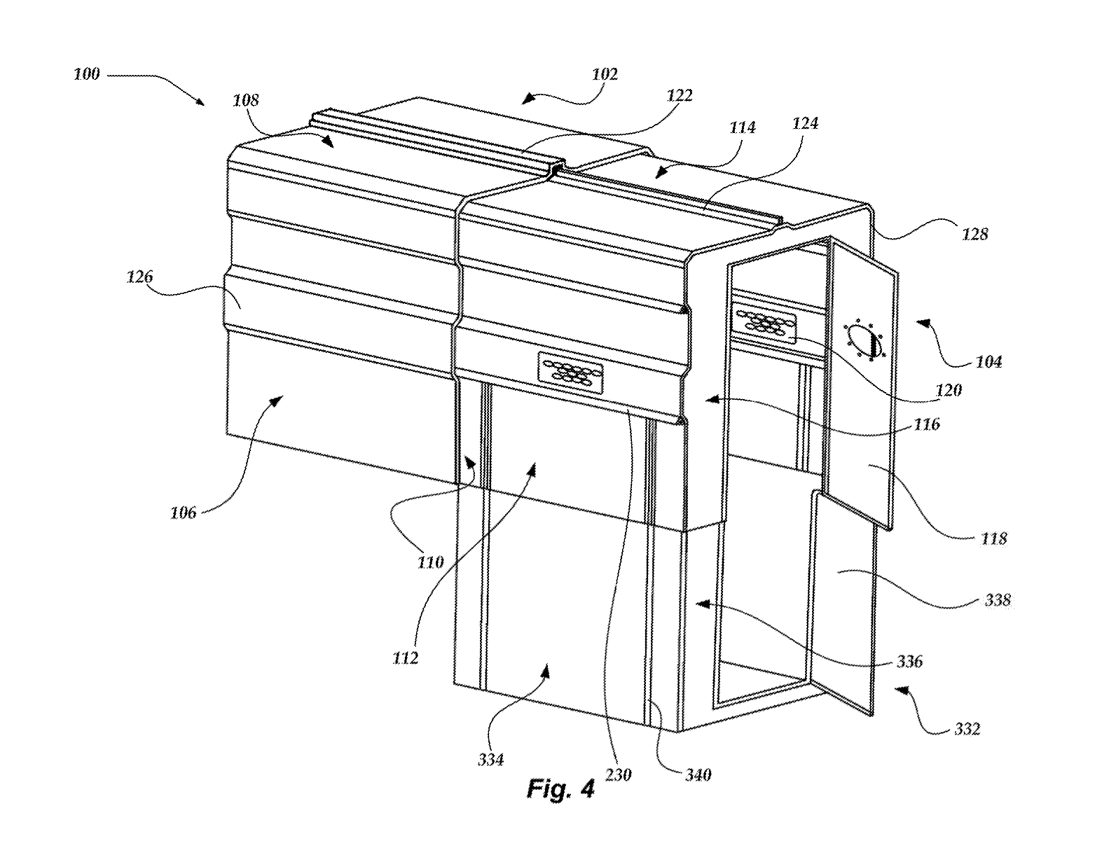

As shown in FIG. 4, door 338 of skirt 332 may align with door 118 of slide box 104 such that they can be opened together, whether skirt 332 is deployed or not.

Shelter 100 may be used as an ice-fishing shelter, as a hunting blind, as a warming hut, or as any other shelter for a person or for cargo or gear. In some embodiments, shelter 100 may deploy quickly and easily without the need to remove normal cargo from the box of the UTV. A pin or other locking device can be removed, the hitch jack secured, and shelter 100 deployed within seconds. Shelter 100 may ride in the box of the UTV and may be ready for quick and easy use when desired.

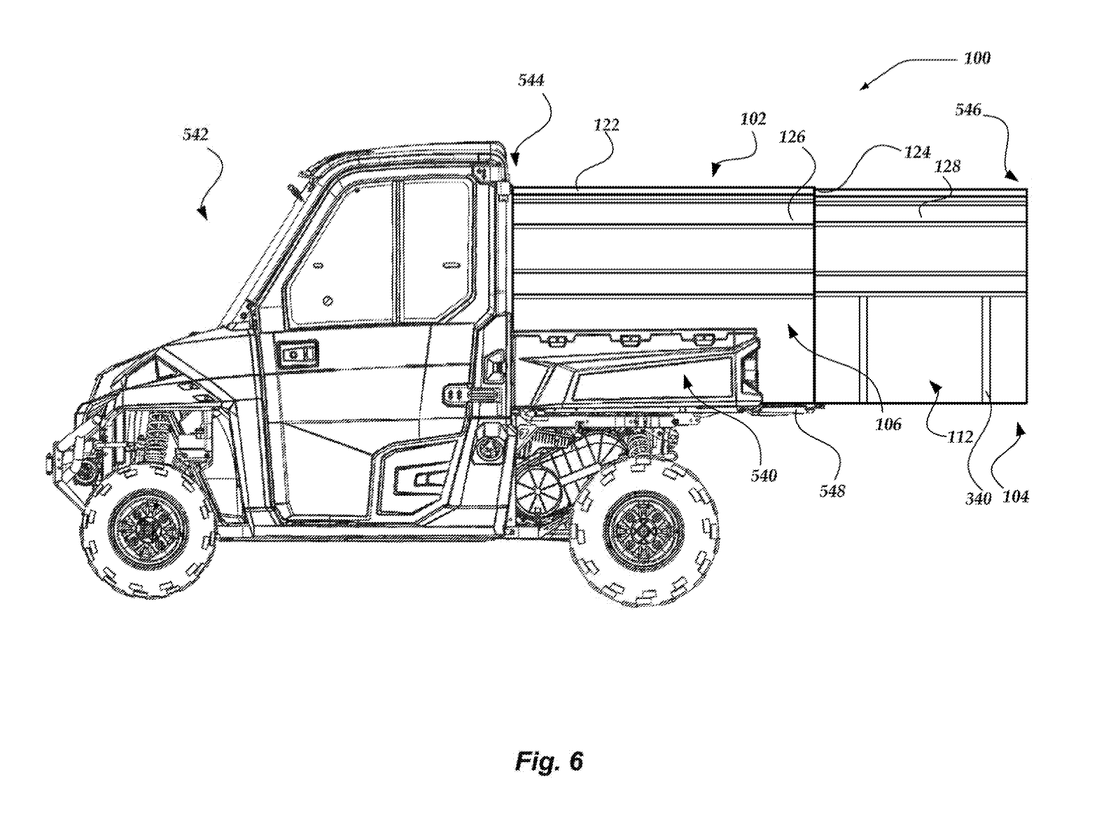

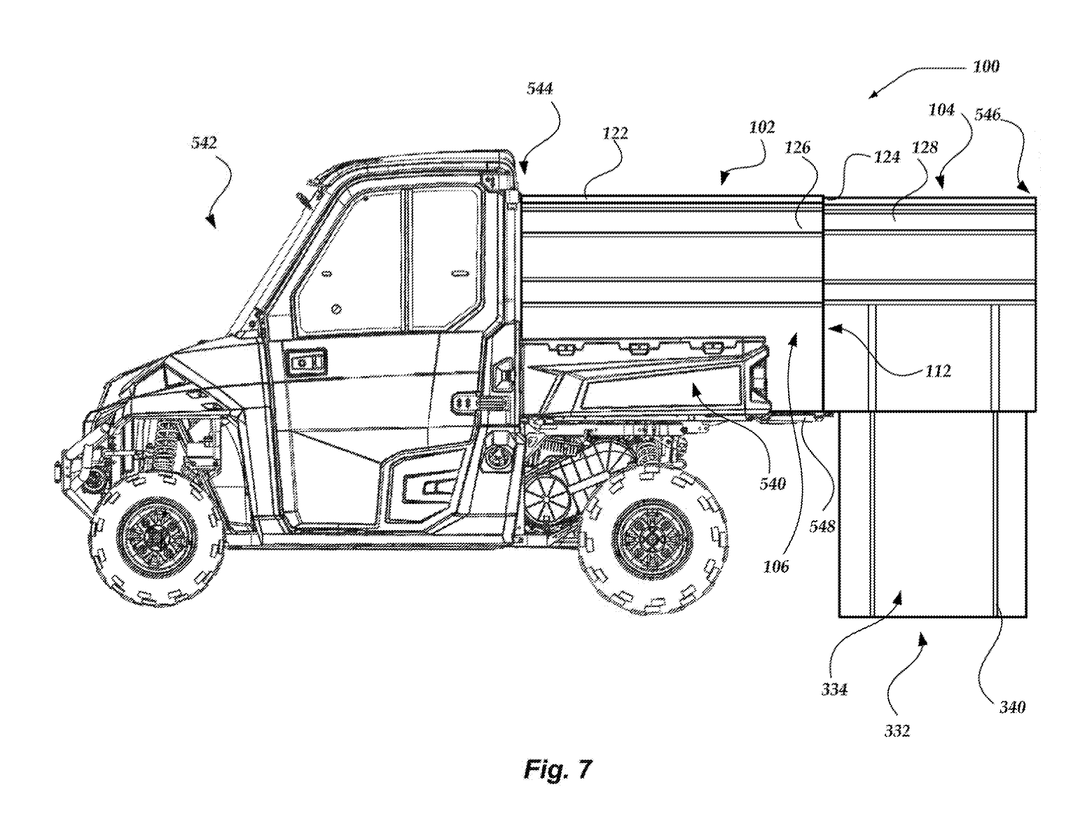

FIG. 5 is an example side view of shelter 100 in the nested configuration, positioned in cargo box 540 of example side-by-side UTV 542. As shown in FIG. 5, shelter 100 is sized and dimensioned such that, when front end portion 544 of shelter 100 abuts the front-most portion of cargo box 540, rear end portion 546 of shelter 100 in the nested configuration aligns with the rear-most portion of tailgate 548 of UTV 542 in the open configuration. FIG. 6 shows shelter 100 in the extended configuration in UTV 542. FIG. 7 shows shelter 100 from the example of FIG. 5 in the deployed configuration in UTV 542. As shown in FIG. 7, skirt 332 is sized and dimensioned and positioned relative to slide box 104 to facilitate transitioning to the deployed configuration without moving main box 102 relative to cargo box 540.

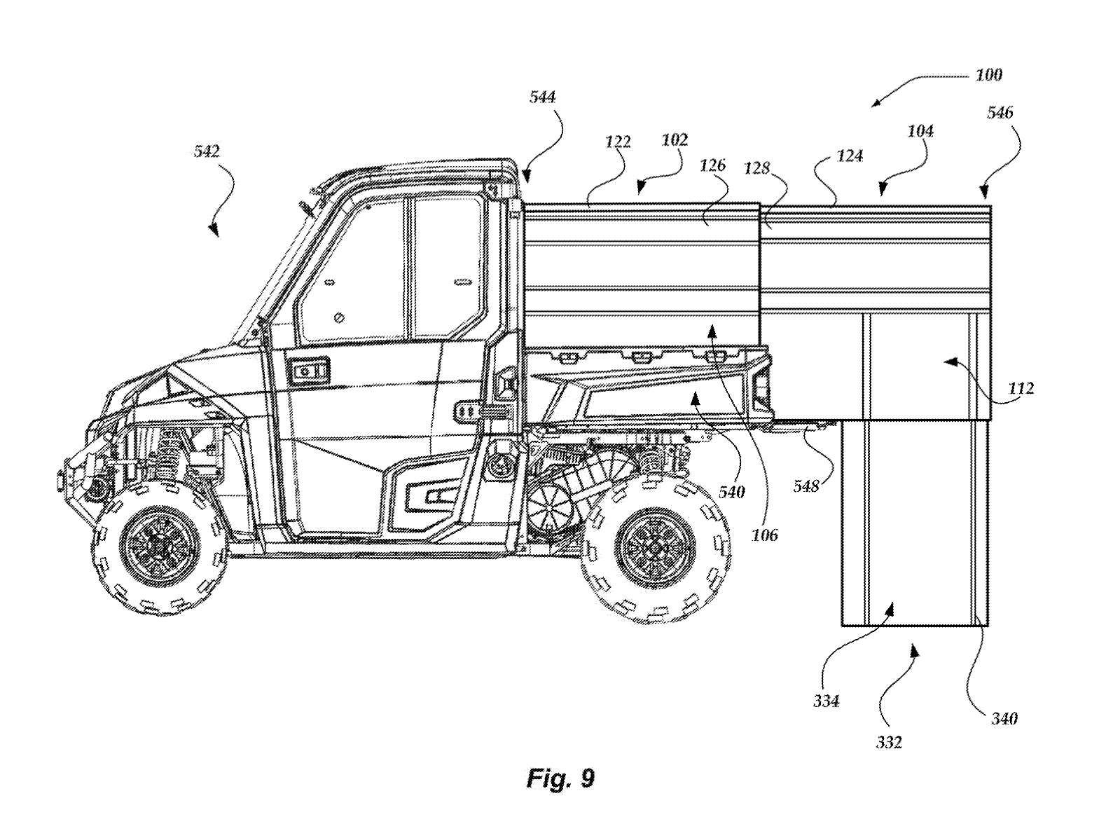

FIG. 8 is another example side view of shelter 100 in the nested configuration, positioned in cargo box 540 of UTV 542. As shown in FIG. 8, shelter 100 is sized and dimensioned such that, when front end portion 544 of shelter 100 abuts the front-most portion of cargo box 540, rear end portion 546 of shelter 100 in the nested configuration fits in cargo box 540 of UTV 542 with tailgate 548 of UTV 542 in the closed configuration. FIG. 9 shows shelter 100 from the example of FIG. 8 in the deployed configuration in UTV 542. As shown in FIG. 9, skirt 332 is sized and dimensioned and positioned relative to slide box 104 to facilitate transitioning to the deployed configuration without moving main box 102 relative to cargo box 540. In the examples shown in FIGS. 8 and 9, tailgate 548 may be opened prior to transitioning shelter 100 from the nested configuration to the extended or deployed configuration and may be closed after returning shelter 100 to the nested configuration.

FIG. 10 is another example side view of shelter 100 in the nested configuration, positioned in cargo box 540 of UTV 542, with left side wall 106, left side wall 112, and left side wall 334 removed to show example internal features. As shown in FIG. 10, main box 102 may have one or more longitudinally extending, low-friction tracks 1002 that act in conjunction with one or more rollers 230 of slide box 104. Each track 1002 may include a rail that is coupled (for example, riveted or bolted) to an inner face of one of the side walls of main box 102. Each roller 230 may include multiple bearings, such as two top bearings and two bottom bearings (optionally, the top bearings may be offset from the bottom bearings in the sliding direction), in a housing that is coupled (for example, riveted or bolted) to an outer face of one of the side walls of slide box 104. Together, track 1002 and roller 230 may include a linear-motion bearing or linear slide, such as rolling-element bearings (for example, ball bearing slides, roller slides, or others), plain bearing (for example, dovetail slides, compound slides, rack slides, or others), or others. In some embodiments, track 1002 and roller 230 may form a drawer slide. The drawer slides may be smoother or faster than other sliding or rolling systems.

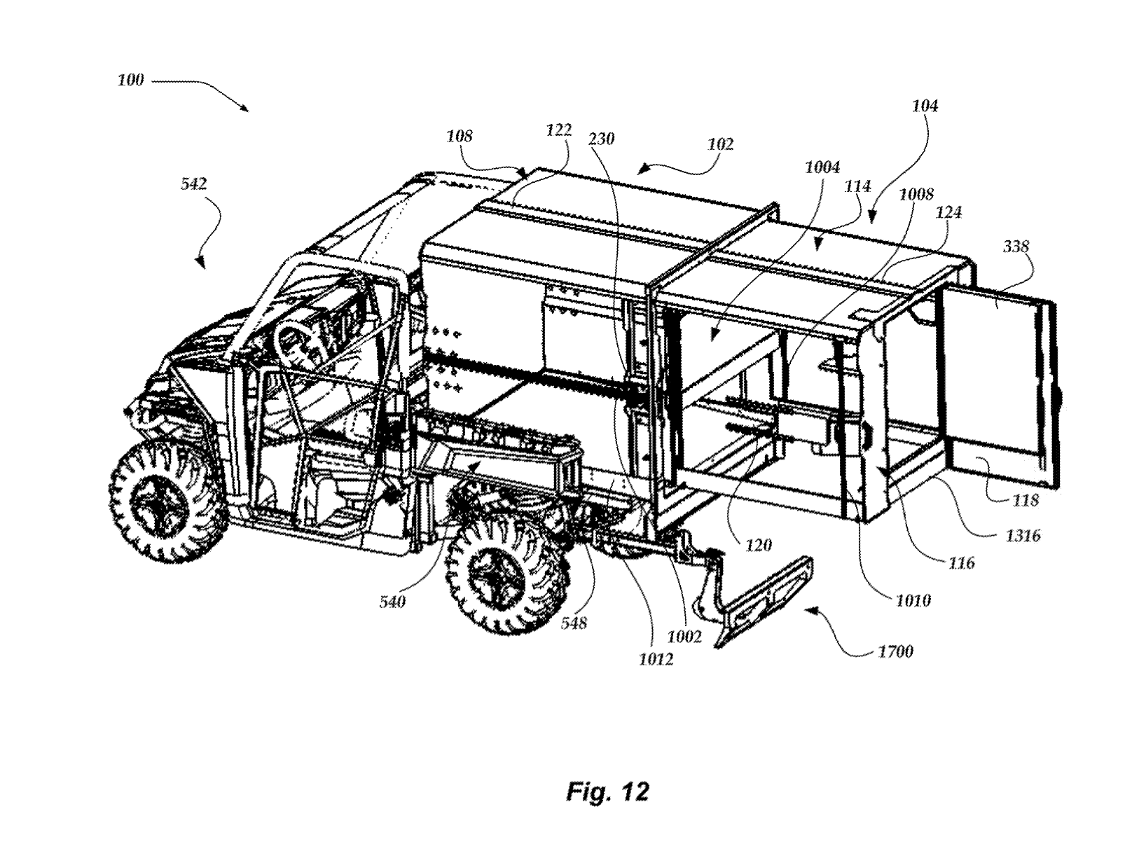

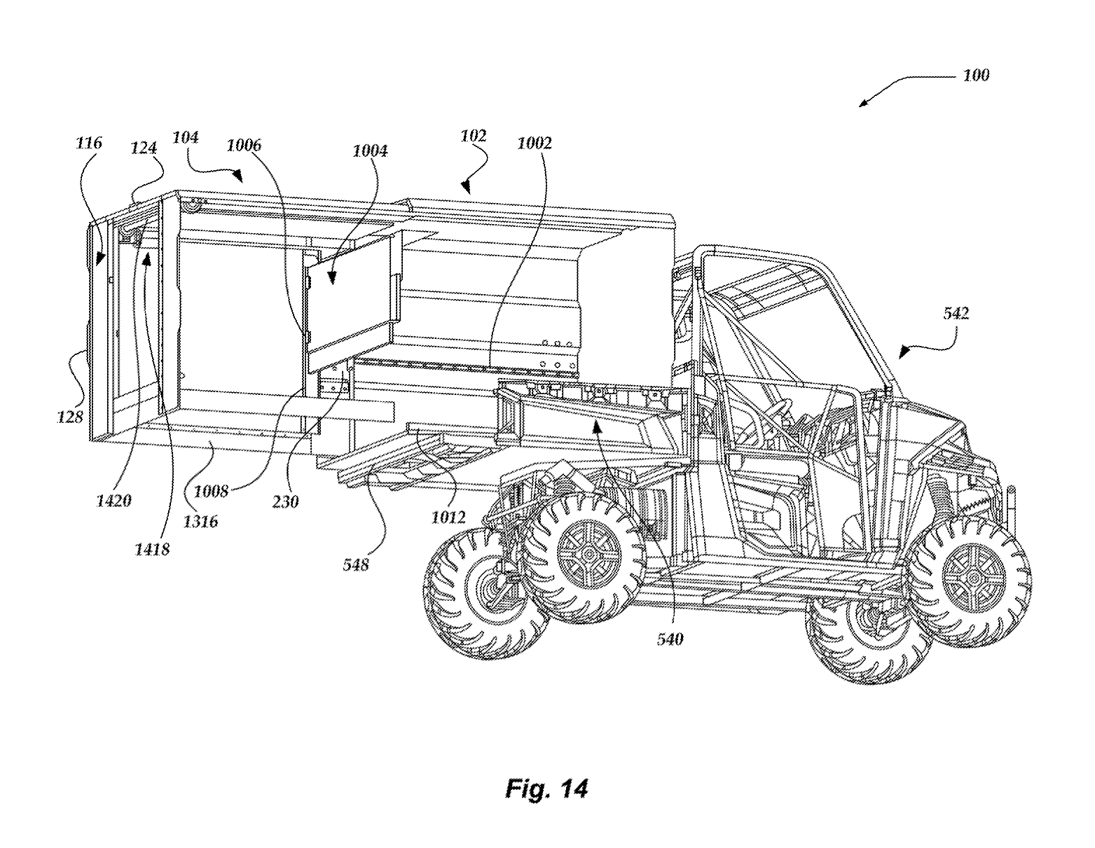

Skirt 332 of shelter 100 may have front wall 1004. As shown in FIG. 10, the bottom edge of front wall 1004 may be disposed on or near (for example, within 6 inches) of the floor of main box 102 when shelter 100 is in the nested configuration. In other examples (see FIG. 11), the bottom edge of front wall 1004 may be spaced apart from the floor of main box 102 by a predetermined distance (for example, at least 15, 18, 21, 24, or more inches) when shelter 100 is in the nested configuration. In some examples, front wall 1004 has one or more rollers 1006 that slidably couple to one or more vertical tracks 1008 that are coupled (for example, riveted or bolted) to one or more inner faces of the side walls of skirt 332. As shown in FIGS. 12 and 14, front wall 1004 of skirt 332 may be disposed at the same vertical position in both the nested configuration and the extended configuration, thereby facilitating transitioning shelter 100 between the nested configuration and the extended configuration without disturbing objects resting on the floor of main box 102.

Slide box 104 may have one or more vertical tracks 1010 that are coupled (for example, riveted or bolted) to one or more inner faces of the walls of slide box 104. One or more rollers 340 of skirt 332 may slidably couple to the one or more vertical tracks 1010. In some examples, slide box 104 may have four vertical tracks 1010, with one being disposed in or near (for example, within 6, 9, 12, or 15 inches) each corner, and skirt 332 may have four sets of roller 340.

Main box 102 may have one or more longitudinally extending, adjustable wedges 1012 that facilitate counteracting the longitudinal slope of the floor of cargo box 540 to provide a horizontal orientation of shelter 100 when vehicle 542 is on horizontal ground. The height of main box 102 at one or more of the front end portion or the rear end portion of main box 102 may be adjusted by adjusting the vertical position of one or more end portions of each wedge 1012 relative to one or more corresponding end portions of main box 102. Each wedge 1012 may be hingeably or slidably coupled to the front end portion of main box 102 and may be slidably coupled to the rear end portion of main box 102. In some examples, each wedge 1012 may provide a vertical adjustment of at least 1, 2, 3, 4, or more inches. In some examples, each wedge 1012 includes aluminum and covers a vertical face of a wooden portion of main box 102, such as the floor of main box 102.

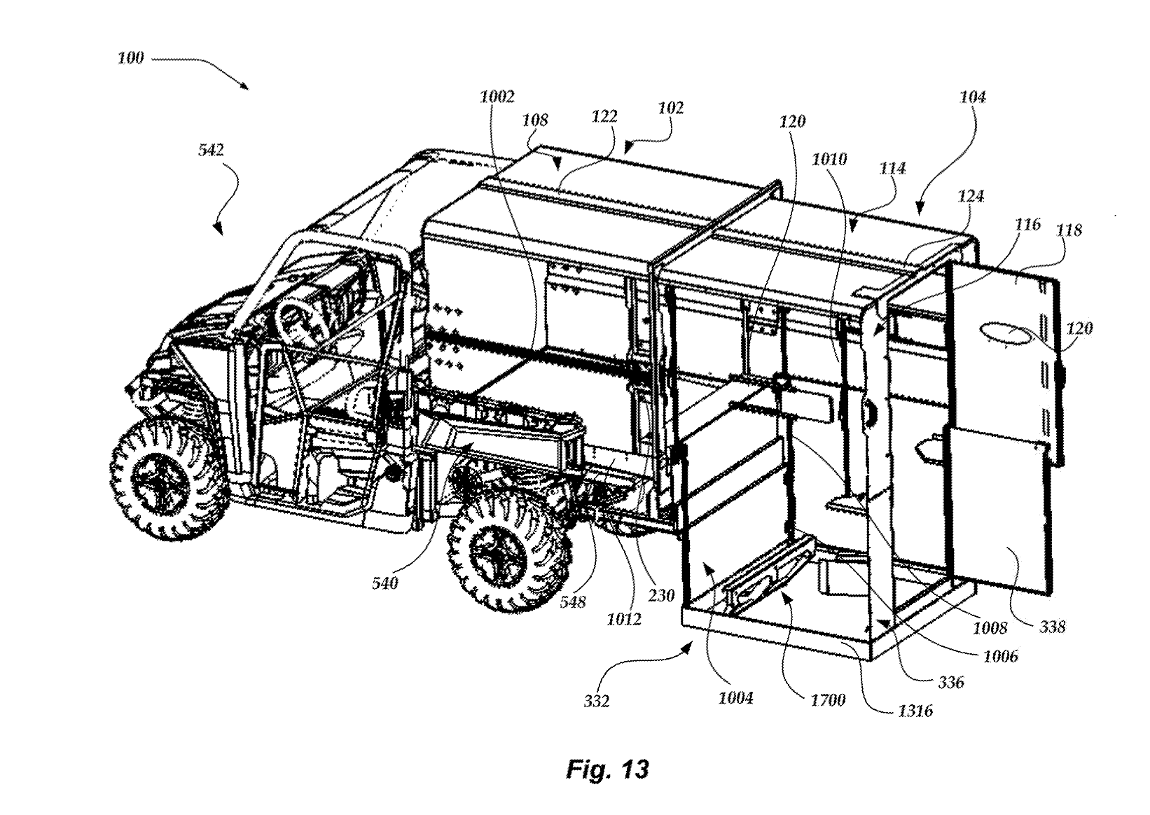

As shown in FIG. 13, skirt 332 may have bottom lip 1316. Bottom lip 1316 may include one or more materials that are different from the one or more materials included in the side walls of skirt 332. The one or more materials in bottom lip 1316 may have one or more characteristics that are different from the one or more materials in the side walls of skirt 332. For example, bottom lip 1316 may be translucent, may not stick to snow or ice, or others. Bottom lip 1316 may extend along the entire bottom perimeter of skirt 332, including the bottom of front wall 1004. In some examples, bottom lip 1316 may include UHMW plastic (for example, UHMW polyethylene).

FIG. 14 shows example prime mover 1418 that may raise and lower skirt 332 relative to slide box 104, thereby facilitating transitioning shelter 100 from the extended configuration to the deployed configuration. In one or more of the various embodiments, prime mover 1418 includes a winch, a worm drive, or others. In some examples, prime mover 1418 rotates shaft 1420. One or more cables may have one end portion that is coupled to skirt 332 and another end portion that winds around one or more portions of rotating shaft 1420. In some examples, the middle portion of shaft 1420 is housed in a non-rotating tube to facilitate attaching accessories to the tube, and one or more cables may wind around one or more of the end portions of shaft 1420. As the one or more cables are unwound from shaft 1420, skirt 332 may lower. One or more of prime mover 1418 or shaft 1420 may be spaced apart from the side walls and rear wall 116 of slide box 104 to facilitate receiving one or more portions of skirt 332 between the one or more of prime mover 1418 or shaft 1420 and one or more of the side walls or rear wall 116 of slide box 104 when transitioning shelter 100 from the deployed configuration to the extended configuration. As the one or more cables are wound around shaft 1420, skirt 332 may raise.

One or more pulleys positioned on or near (for example, within 6 inches) the roof of slide box 104 may route the one or more cables. In some examples, one or more pulleys are positioned in each upper corner of slide box 104. In other examples, pulleys are only located at the upper front end corners of slide box 104. A spring may be coupled to skirt 332 and to the skirt end portion of each cable to facilitate maintaining tension in each cable when skirt 332 is fully lowered. In some examples, four cables are coupled to skirt 332 and shaft 1420, with one cable coupled to skirt 332 in or near (for example, within 6, 9, 12, or 15 inches) each corner of skirt 332. The cables or springs may couple to skirt 332 at the bottom of skirt 332, such as immediately above lip 1316. In some examples, one or more cables have one end portion that is coupled to front wall 1004 and another end portion that winds around one or more portions of rotating shaft 1420, thereby facilitating raising and lowering front wall 1004 relative to skirt 332 and slide box 104.

Shelter 100 may have a cable track that runs along the ceiling of one or more of main box 102 or slide box 104. The cable track may house one or more cables that deliver power to prime mover 1418 from one or more power sources disposed at the front end portion of shelter 100 or in vehicle 542. One or more cable coilers may be disposed at one or more end portions of the cable track. Each cable coiler may automatically coil one or more cables in the track as the shelter transitions from the extended configuration to the nested configuration and may automatically uncoil the one or more cables in the track as the shelter transitions from the nested configuration to the extended configuration. The cable track may be disposed in the inner recess below one or more ridges 122 or ridges 124. In some examples, each track includes a plastic box that has a removable or openable bottom cover to facilitate providing access to one or more cables housed in the track. Each cable coiler may be coupled to one or more walls of one or more of main box 102 or slide box 104. One or more cable coilers may coil one or more coils around a vertical axis or a lateral axis.

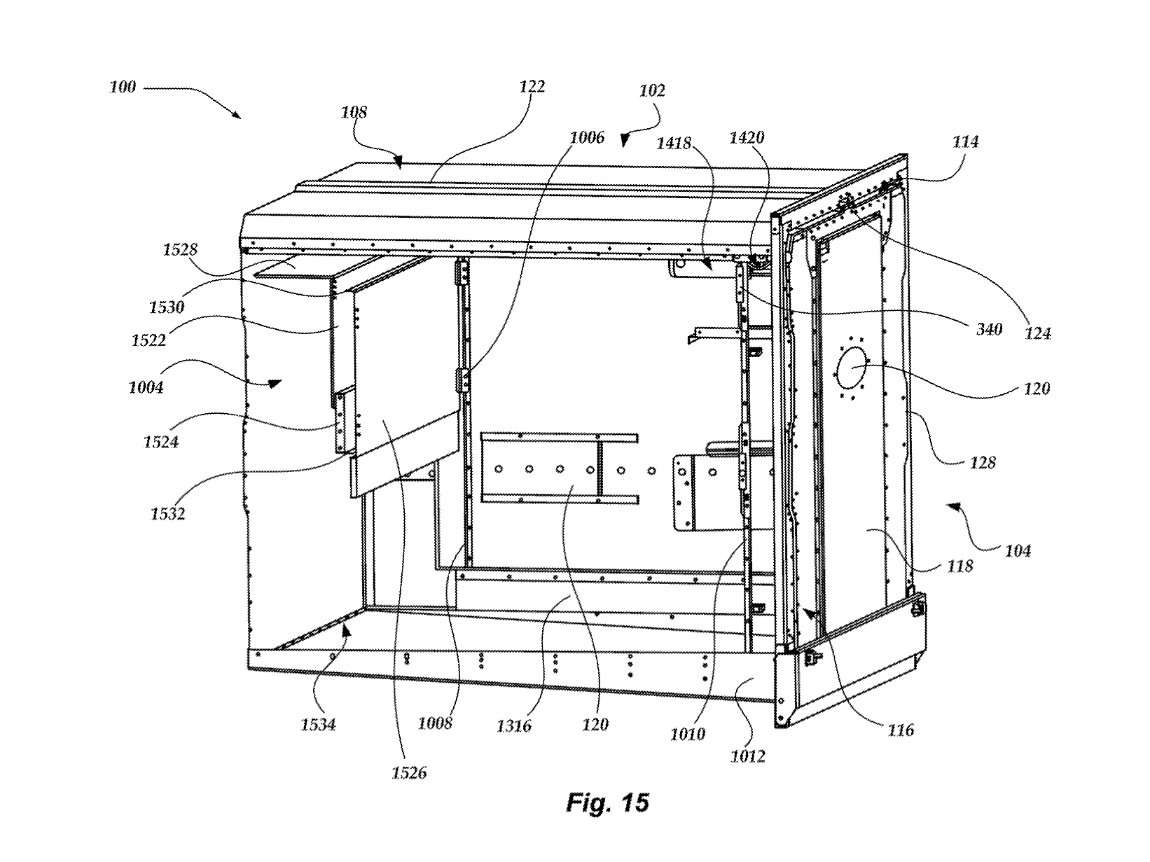

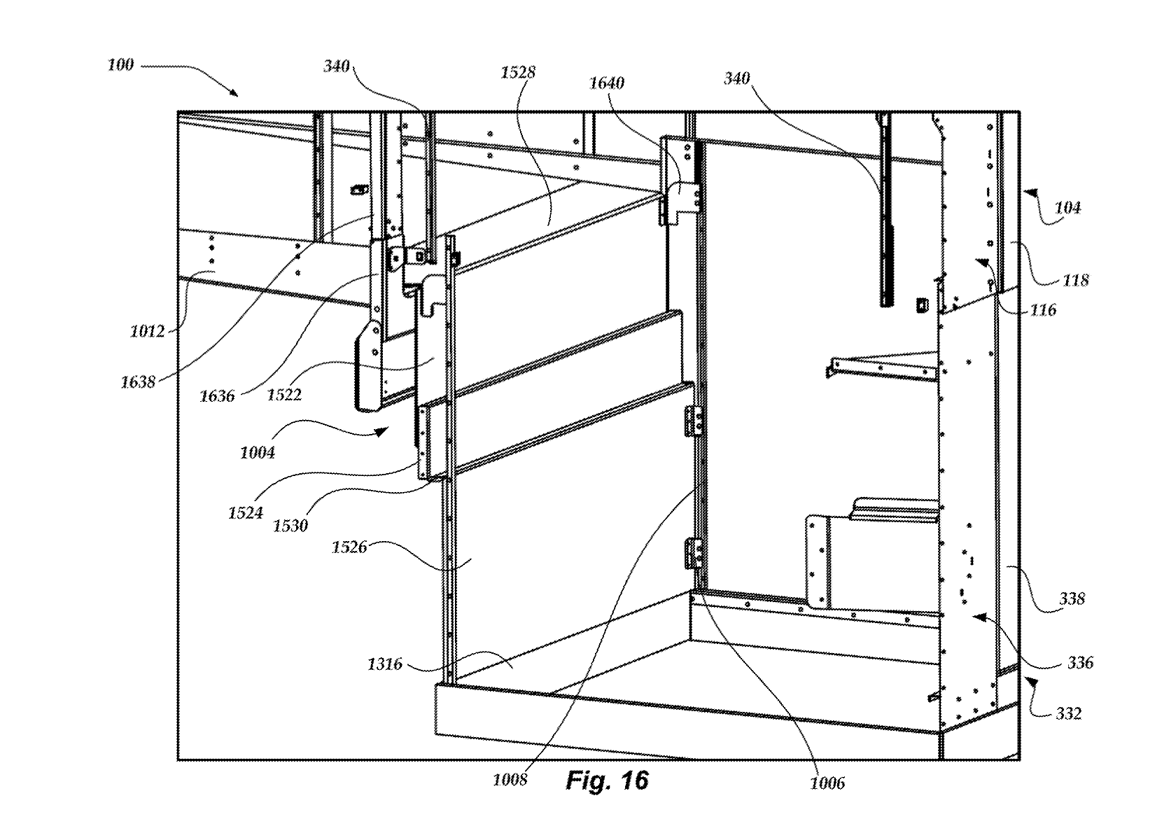

As shown in FIG. 15, front wall 1004 may have collapsible or telescoping components. Front wall 1004 may have upper portion 1522, middle portion 1524, and lower portion 1526. Other examples of front wall 1004 include fewer or more collapsible or telescoping components. Upper portion 1522 may have one or more forward-extending portions 1528 that extend from the upper end portion of upper portion 1522. Each forward-extending portion 1528 may have a longitudinal length, such as 2, 4, 6, 8, 10, 12, or more inches. In the nested configuration, each forward-extending portion 1528 may act as a shelf (see FIGS. 10, 11, and 15). In the deployed configuration, each forward-extending portion 1528 may rest on the floor of main box 102 where a person may sit while ice fishing (see FIGS. 13 and 16).

Middle portion 1524 may be fixedly coupled to the bottom end portion of upper portion 1522. The upper end portion of lower portion 1526 may have one or more forward-extending portions 1530. During one or more portions of the transition from the extended configuration to the deployed configuration, each forward-extending portion 1530 may contact one or more corresponding top surfaces of middle portion 1524. Accordingly, during the beginning portion of the transition from the extended configuration to the deployed configuration, lower portion 1526 may begin to move downward relative to one or more of upper portion 1522 or middle portion 1524. In some examples, skirt 332 begins moving downward while lower portion 1526 moves downward relative to one or more of upper portion 1522 or middle portion 1524. In other examples, skirt 332 does not begin moving downward until front wall 1004 is fully lowered relative to skirt 332. In some examples, front wall 1004 moves downward with skirt 332 yet does not begin moving downward relative to skirt 332 until skirt 332 reaches its final position in the deployed configuration. In the deployed configuration, each forward-extending portion 1530 may contact the one or more corresponding top surfaces of middle portion 1524.

The bottom end portion of lower portion 1526 may have one or more forward-extending portions 1532. During one or more portions of the transition from the deployed configuration to the extended configuration, each forward-extending portion 1532 may contact one or more corresponding bottom surfaces of middle portion 1524. Accordingly, during the beginning portion of the transition from the deployed configuration to the extended configuration, lower portion 1526 may begin to move upward relative to one or more of upper portion 1522 or middle portion 1524. In some examples, skirt 332 begins moving upward while lower portion 1526 moves upward relative to one or more of upper portion 1522 or middle portion 1524. In other examples, skirt 332 does not begin moving upward until front wall 1004 is fully raised relative to skirt 332. In some examples, front wall 1004 moves upward with skirt 332 yet does not begin moving upward relative to skirt 332 until skirt 332 reaches its final position in the extended configuration. In the extended configuration and the nested configuration, each forward-extending portion 1532 may contact the one or more corresponding bottom surfaces of middle portion 1524.

The timing or order of raising or lowering various components of shelter 100 may be controlled by varying the amount of slack in the cables when in the deployed configuration. To increase the slack in a cable in the deployed configuration, the length of the portion of the cable between a component and shaft 1420 is increased. To decrease the slack in the deployed configuration, the length of the portion of the cable between the component and shaft 1420 is decreased. In some examples, decreasing the slack in one or more cables associated with a component facilitates raising the component earlier in comparison to the one or more cables having an increased amount of slack. In some examples, increasing the slack facilitates lowering the component earlier in comparison to the one or more cables having a decreased amount of slack. In the deployed configuration, the slack in the cables that couple to skirt 332 nearer to rear wall 116 than front wall 1004 may be greater than the slack in the cables that couple to skirt 332 nearer to front wall 1004 than rear wall 116. In some examples, prime mover 1418 has a wobble switch or a slack cable switch that is actuated when prime mover 1418 lets out a predetermined amount of cable and that, when actuated, stops prime mover 1418 to prevent one or more cables from being wound back around shaft 1420 and causing skirt 332 to lift in a crooked orientation. In some examples, the switch may be actuated when tension on one or more cables is removed or when a detected amount of slack exceeds a predetermined threshold. In other examples, shaft 1420 has multiple portions that rotate at different times during the transition, with different components of shelter 100 being coupled by cables to different portions of shaft 1420, to facilitate controlling the timing of raising or lowering the components.

As shown in FIG. 15, one or more hinges 1534 may couple one or more wedges 1012 or the floor of main box 102 to the front wall of main box 102. As shown in FIG. 16, one or more components at the rear end portion of main box 102 may vertically slide relative to each wedge 1012 and may lock to each wedge 1012. One or more rear brackets 1636 may be fixedly coupled to one or more uprights 1638 of main box 102 and may slidably and lockably couple to one or more wedges 1012. In other examples, one or more uprights 1638 slidably and lockably couple directly to one or more wedges 1012. One or more wedges 1012 may be lockable to one or more brackets 1636 or uprights 1638 with one or more removable pins that may be inserted into or removed from one or more holes in one or more wedges 1012 and one or more corresponding holes in one or more brackets 1636 or uprights 1638. In other examples, one or more wedges 1012 may be lockable to one or more brackets 1636 or uprights 1638 with one or more bolts.

As shown in FIG. 16, upper portion 1522 of front wall 1004 may slidably couple to one or more tracks 1008 with one or more rollers 1640. Each roller 1640 may include a bracket that extends rearward from upper portion 1522 to a corresponding track 1008.

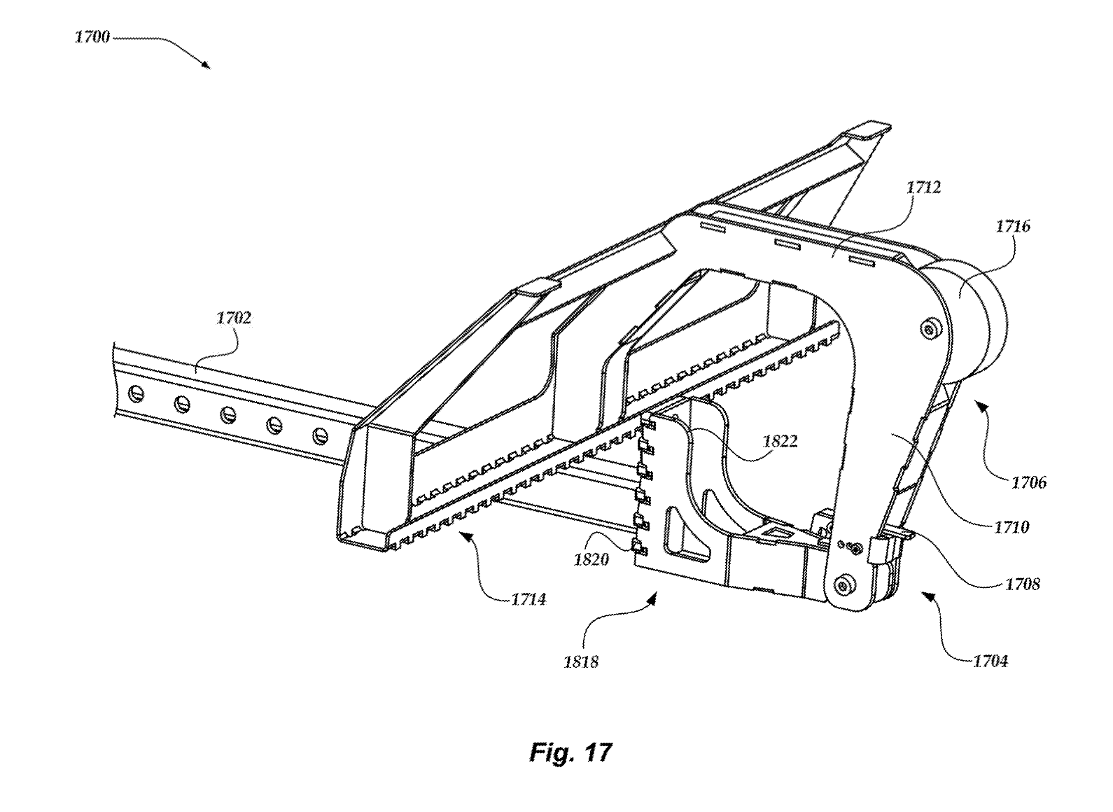

FIG. 17 shows example suspension stabilizer 1700 in a stored configuration (see also FIG. 10). Suspension stabilizer 1700 has mount shank 1702, and the front end portion of mount shank 1702 may be inserted in the hitch receiver of vehicle 542. In some examples, one or more portions of mount shank 1702 are telescoping or otherwise collapsible while the front end portion of mount shank 1702 is disposed in the hitch receiver. As shown in FIG. 17, mount shank 1702 is fixed and not collapsible or telescoping, thereby facilitating preventing components of suspension stabilizer 1700 from locking due to freezing. Hinge and lock mechanism 1704 may be disposed at the rear end portion of mount shank 1702 and may hingeably couple stabilizing body 1706 to mount shank 1702. When transitioned into the stored configuration from a stabilizing configuration (see FIGS. 11-13 and 18), hinge and lock mechanism 1704 may automatically lock, thereby maintaining the stored configuration. As shown in FIG. 17, mechanism 1704 includes lever 1708 that, when actuated (for example, lifting the rear end portion of lever 1708), unlocks mechanism 1704, thereby facilitating transitioning stabilizer 1700 from the stored configuration to the stabilizing configuration.

Stabilizing body 1706 may have two beams, including upright beam 1710 and longitudinal beam 1712. Upright beam 1710 may extend from hinge and lock mechanism 1704 to longitudinal beam 1712. Longitudinal beam 1712 may extend from upright beam 1710 to step 1714. Wheel 1716 may be rotatably coupled to stabilizing body 1706. In some examples, wheel 1716 is rotatably coupled to body 1706 at an elbow in body 1706 where upright beam 1710 and longitudinal beam 1712 meet each other.

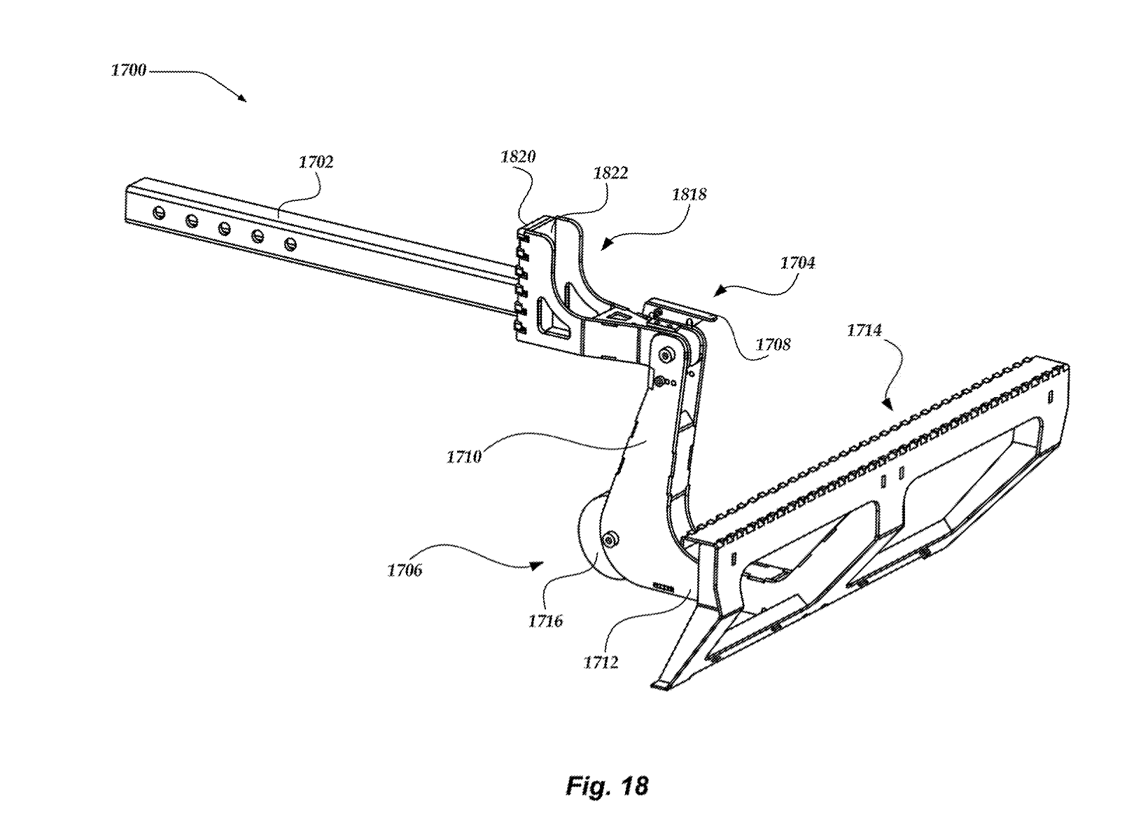

FIG. 18 shows suspension stabilizer 1700 in the stabilizing configuration. In the stabilizing configuration, the vertical distance between the bottom of body 1706 and the bottom of mount shank 1702 may exceed the vertical distance between the ground and the bottom of mount shank 1702 when stabilizer 1700 is in the stored configuration. Accordingly, by transitioning stabilizer 1700 into the stabilizing configuration, vehicle 542 may be slightly lifted, thereby facilitating stabilizing vehicle 542 and reducing the load imposed on the suspension of vehicle 542.

As shown in FIG. 18, suspension stabilizer 1700 has height adjuster 1818, which may be disposed between the rear end portion of mount shank 1702 and hinge and lock mechanism 1704. Height adjuster 1818 may facilitate adjusting the vertical distance between the bottom of body 1706 and the bottom of mount shank 1702 when stabilizer 1700 is in the stabilizing configuration. In the example of FIG. 18, height adjuster 1818 has front plate 1820 and rear plate 1822. Front plate 1820 may be fixedly coupled to mount shank 1702 (for example, welded). Rear plate 1822 may be fixedly coupled to hinge and lock mechanism 1704. Rear plate 1822 may be adjustably coupled (for example, bolted) to front plate 1820. Front plate 1820 may have multiple laterally extending teeth. Rear plate 1822 may have multiple forward extending teeth. The teeth of rear plate 1822 may be inserted between the teeth of front plate 1820, and rear plate 1822 may be coupled to front plate 1820 to secure rear plate 1822 at a desired vertical position relative to front plate 1820. Adjuster 1818 may provide 6, 9, 12, 15, or more inches of vertical adjustment.

In the process of transitioning stabilizer 1700 from the stored configuration to the stabilizing configuration, the user may encounter resistance when wheel 1716 contacts the ground. At that point in the process, the user may step on and apply downward force to the top of step 1714 to complete the transition of stabilizer 1700 into the stabilizing configuration. In the stabilizing configuration, the center of wheel 1716 may be disposed forward of the lateral axis of the hinge of hinge and lock mechanism 1704 to facilitate preventing inadvertent transitioning out of the stabilizing configuration.

As shown in FIG. 13, step 1714 may act as a footrest for a user sitting on forward-extending portion 1528. Longitudinal beam 1712 may extend under the bottom portion of front wall 1004 or the front portion of lip 1316 when shelter 100 is in the deployed configuration and stabilizer 1700 is in the stabilizing configuration. In some examples, the bottom portion of front wall 1004 or the front portion of lip 1316 has an upward-extending notch that receives longitudinal beam 1712 as skirt 332 is lowered toward the ground.

Shelter 100 may have one or more auger mounts coupled to one or more external faces of one or more side walls of main box 102 to facilitate storing and transporting one or more ice augers. Each auger mount may include multiple hooks that are vertically aligned with each other, that are longitudinally spaced apart from each other, and that laterally extend outward from one of the side walls of shelter 100 to facilitate vertically supporting and laterally retaining an ice auger. In some examples, one or more of the hooks have one or more hingeable latching portions that facilitate removably securing an ice auger to shelter 100. Each auger mount may have a blade cover disposed at one or both of the longitudinal end portions of one of the side walls of main box 102. Each blade cover may include a plate that laterally extends outward from a side wall of main box by a distance that exceeds the diameter or width of a typical motorized ice auger used for ice fishing. In some examples, the plate of each blade cover has a height that matches the width of the plate (for example, square, circular, or otherwise shaped to cover the end portion of an auger blade). Each blade cover may have one or more lips that at least partially (for example, half, three quarters, or an entirety) extend along the circumferential perimeter of the plate and that longitudinally extend from the plate toward the opposite end portion of the corresponding auger mount by a predetermined distance, such as 0.5, 1, 2, 3, 4, or more inches. In some examples, each lip includes rubber or plastic material. Each auger mount facilitates storing an auger without having a cover that extends over a substantial length of the auger (for example, 10, 25, 50, or more percent of the length of the auger blade or the entire auger). Accordingly, each auger mount facilitates saving time and effort in loading and unloading an auger in comparison to a longitudinal tube that houses the entirety of the auger, while also protecting the auger blade and users from inadvertent contact with the distal end of the auger blade.

The terms “front,” “rear,” “top,” “bottom,” “frontward,” and “rearward” are used consistently with respect to all elements and are defined relative to rear face 116 of shelter 100. The terms “longitude,” “longitudinal,” “lateral,” “width,” and “height” are also used consistently with respect to all elements and are defined relative to the longitudinal axis of shelter 100. The longitudinal axis of shelter 100 extends from rear face 116 to the front-most portion of shelter 100. The lateral axis of shelter 100 is perpendicular to the longitudinal axis of shelter 100. The width of shelter 100 is transverse to the longitudinal axis of shelter 100 (for example, parallel to the lateral axis of shelter 100) and, when disposed on a flat surface, is parallel to the flat surface. The height of shelter 100 is transverse to the longitudinal axis and the width of shelter 100.

The foregoing examples should not be construed as limiting or exhaustive, yet rather, illustrative use cases to show implementations of at least one of the various embodiments of the invention. Accordingly, many changes can be made without departing from the spirit and scope of the invention. For example, although the figures show slide box 104 extending rearward of main box 102, main box 102 may have a left-side or right-side opening to facilitate extending slide box 104 to the left or right side of main box 102 and over the upper side edge of cargo box 540 (instead of over lowered tailgate 548). Thus, the scope of the invention is not limited by the disclosure of the examples. Instead, the invention should be determined entirely by reference to the claims that follow.

The embodiments of the invention in which an exclusive property or privilege is claimed are defined as follows:

1. An expandable shelter, comprising:
a slide box;
a skirt slidably coupled to the slide box, with the skirt being vertically slidable relative to the slide box; and
a prime mover that raises and lowers the skirt relative to the slide box.

2. The expandable shelter of claim 1, wherein the slide box has multiple side walls, the prime mover is mounted inside the slide box, and the prime mover is spaced apart from each of the side walls of the slide box.

3. The expandable shelter of claim 1, further comprising:
a main box having a first side wall, a second side wall, and a side opening, the first and second side walls being disposed opposite the side opening from each other;
a first track that extends along an inner face of the first side wall of the main box;
a second track that extends along an inner face of the second side wall of the main box;
a first roller fixedly coupled to an external face of a first side wall of the slide box, the first roller being slidably coupled to the first track; and
a second roller fixedly coupled to an external face of a second side wall of the slide box, the second roller being slidably coupled to the second track, with the slide box being slidable at least partially through the side opening of the main box.

4. The expandable shelter of claim 1, further comprising a main box having a side opening and one or more wedges, the slide box being slidably coupled to the main box, with the slide box being slidable at least partially through the side opening of the main box, the one or more wedges extending along a bottom of one or more sides of the main box, the one or more wedges having one or more end portions that are vertically adjustable relative to the main box, and vertical adjustment of the one or more wedges raises or lowers a portion of the main box.

5. The expandable shelter of claim 1, wherein the skirt has a front wall that collapses when the skirt slides toward the slide box and that extends when the skirt slides away from the slide box.

6. The expandable shelter of claim 1, wherein the skirt has a front wall that is vertically slidable relative to the slide box and relative to the skirt.

7. The expandable shelter of claim 1, wherein the skirt has a bottom lip that includes ultra high molecular weight (UHMW) plastic.

8. The expandable shelter of claim 1, further comprising a main box having a side opening and an auger mount, the slide box being slidably coupled to the main box, with the slide box being slidable at least partially through the side opening of the main box, and the auger mount having one or more hooks and a blade cover at an end portion of the auger mount.

9. The expandable shelter of claim 1, further comprising a suspension stabilizer, the suspension stabilizer including a mount shank and a stabilizing body, the mount shank being sized and dimensioned to be received in a hitch receiver, the stabilizing body being pivotally coupled to the mount shank, the stabilizing body being pivotable relative to the mount shank between a stabilizing configuration and a stored configuration, and transitioning the suspension stabilizer in the hitch receiver from the stored configuration to the stabilizing configuration increases a vertical distance between ground and the hitch receiver.

10. The expandable shelter of claim 1, further comprising a suspension stabilizer, the suspension stabilizer including a mount shank, the mount shank being sized and dimensioned to be received in a hitch receiver, the suspension stabilizer being transitionable between a stabilizing configuration and a stored configuration, and transitioning the suspension stabilizer in the hitch receiver from the stored configuration to the stabilizing configuration provides a step or footrest for a user in the skirt.

11. An expandable shelter, comprising:
a main box having a first side wall, a second side wall, and a side opening, the first and second side walls of the main box being disposed opposite the side opening from each other, each of the first and second side walls of the main box having an inner face;
a slide box having a first side wall, a second side wall, and a bottom opening disposed between the first and second side walls, each of the first and second side walls of the slide box having an external face, the slide box being slidably coupled to the main box, with the slide box being slidable at least partially through the side opening of the main box;
a first track that extends along the inner face of the first side wall of the main box;
a second track that extends along the inner face of the second side wall of the main box;
a first roller fixedly coupled to the external face of the first side wall of the slide box, the first roller being slidably coupled to the first track; and
a second roller fixedly coupled to the external face of the second side wall of the slide box, the second roller being slidably coupled to the second track.

12. The expandable shelter of claim 11, wherein the first roller and the first track form a first drawer slide, and the second roller and the second track form a second drawer slide, with each of the first and second rollers having multiple top bearings disposed above one of the first and second tracks and having multiple lower bearings disposed under one of the first and second tracks.

13. A method of expanding a shelter, comprising:
providing a slide box that houses a skirt, the skirt being vertically slidable relative to the slide box; and
actuating a prime mover that raises or lowers the skirt relative to the slide box.

14. The method of claim 11, further comprising:
providing a main box having a first side wall, a second side wall, and a side opening, the first and second side walls being disposed opposite the side opening from each other; and
sliding the slide box at least partially through the side opening of the main box, the slide box having a first roller fixedly coupled to an external face of a first side wall of the slide box and having a second roller fixedly coupled to an external face of a second side wall of the slide box, the first roller being slidably coupled to a first track that extends along an inner face of the first side wall of the main box, and the second roller being slidably coupled to a second track that extends along an inner face of the second side wall of the main box.

15. The method of claim 11, further comprising:
providing a main box having one or more wedges, the slide box being slidably coupled to the main box, the one or more wedges extending along a bottom of one or more sides of the main box;
sliding the slide box at least partially through the side opening of the main box; and
adjusting a vertical position of one or more end portions of the one or more wedges relative to the main box to raise or lower a portion of the main box.

16. The method of claim 11, further comprising
sliding the skirt away from the slide box;
extending a front wall of the skirt;
collapsing the front wall of the skirt; and
sliding the skirt toward the slide box with the skirt being collapsed.

17. The method of claim 11, wherein the skirt has a bottom lip that includes ultra high molecular weight (UHMW) plastic.

18. The method of claim 11, further comprising:
providing a main box having an auger mount, the slide box being slidably coupled to the main box, the auger mount having one or more hooks and a blade cover at an end portion of the auger mount; and
setting an ice auger onto the one or more hooks with a blade of the ice auger being at least partially covered by the blade cover.

19. The method of claim 11, further comprising:
inserting a mount shank of a suspension stabilizer into a hitch receiver;
pivoting a stabilizing body of the suspension stabilizer relative to the hitch receiver to transition the suspension stabilizer from a stored configuration to a stabilizing configuration, with a vertical distance between ground and the hitch receiver being greater when the suspension stabilizer is in the stabilizing configuration than when the suspension stabilizer is in the stored configuration.

20. The method of claim 11, further comprising:
inserting a mount shank of a suspension stabilizer into a hitch receiver; and
transitioning the suspension stabilizer from a stored configuration to a stabilizing configuration to provide a step or footrest for a user in the skirt.
